(19) United States
(12) Patent Application Publication
(10) Pub. No.: US 2026/0356547 A1
(43) Pub. Date: Nov. 12, 2026

(54) ULTRASONICALLY-SEALED CELLULOSIC CONTAINERS FOR HOUSEHOLD PRODUCTS

(71) Applicant: THE PROCTER & GAMBLE COMPANY, Cincinnati, OH (US)

(72) Inventors: Andrea BRANCA, Brussels (BE); Federico PIRONTI, Grimbergen (BE); Henri Theo Leonie RUERS, Antwerp (BE); Deniz Alp SAVASKAN, Brussels (BE)

(21) Appl. No.: 19/648,240

(22) Filed: Apr. 15, 2026

(30) Foreign Application Priority Data
Apr. 15, 2025 (EP) 25170832.7
Feb. 24, 2026 (EP) 26160324.5

(51) Int. Cl. B65D 43/02; C11D 17/04

(52) U.S. Cl. CPC B65D 43/0235; C11D 17/046; B65D 2401/25; B65D 2543/00092; B65D 2543/00537; C11D 2111/12

(57) ABSTRACT

A cylindrical container includes cellulosic material, wherein the cylindrical container comprises a body portion having a first end and a second end, wherein the first end comprises a first closure and the second end comprises a second closure, wherein the first closure is sealed to the first end, wherein the second closure and a lid wall are part of a removeable lid, wherein the second closure is sealed to the lid wall in the second end, wherein the removable lid comprises cellulosic material, characterised in that the first closure is sealed to the first end by ultrasonic sealing, wherein the ultrasonic sealing seals a plurality of layers of cellulosic material, preferably two or three layers of cellulosic material, to form a first seal, or wherein the second closure is sealed to the lid wall by ultrasonic sealing, wherein the ultrasonic sealing seals a plurality of layers of cellulosic material, preferably two or three layers of cellulosic material, to form a second seal, or combinations thereof.

### TECHNICAL FIELD

The present disclosure relates to a cylindrical container comprising cellulosic material sealed by ultrasonic sealing.

### BACKGROUND

Packaging for laundry products is made from different shapes and materials.

Cellulosic fibers are currently being used to produce carton or paper-based packaging in order to address environmental concerns linked to the use of plastic materials. The adoption of carton packaging poses a new technical challenge related to the sealing of carton packaging parts. In cylindrical containers, the main challenge remains the sealing of the bottom disk and of the top disk of the lid.

The commonly-used process for sealing carton cylindrical containers is based on the use of glues or of external heating sources, such as hot air, which often results in containers presenting structural weaknesses at the points of sealing or of weak seals that rupture easily when mishandled by the consumer.

Moreover, hot air sealing is linked with a heightened risk of fires due to carton's flammability. Hot air sealing and glue sealing are also slow processes that can create bottlenecks during manufacturing.

Ultrasonic sealing is a sealing process that uses high-frequency ultrasonic waves to generate localized heat through friction, which fuses materials together.

There is a current need in the industry to provide carton packaging sealed in a way to solve these challenges, thus providing resistant seals on packaging containers.

### SUMMARY

In a first aspect, the present disclosure relates to a cylindrical container (10) comprising cellulosic material, wherein the cylindrical container (10) comprises a body portion (50) having a first end (30) and a second end (40), wherein the first end (30) comprises a first closure (34) and the second end (40) comprises a second closure (93), wherein the first closure (34) is sealed to the first end (30), wherein the second closure (93) and a lid wall (92) are part of a removeable lid (90), wherein the second closure (93) is sealed to the lid wall (92) in the second end (40), wherein the removable lid (90) comprises cellulosic material, characterised in that the first closure (34) is sealed to the first end (30) by ultrasonic sealing, wherein the ultrasonic sealing seals a plurality of layers of cellulosic material, preferably two or three layers of cellulosic material, to form a first seal, or wherein the second closure (93) is sealed to the lid wall (92) by ultrasonic sealing, wherein the ultrasonic sealing seals a plurality of layers of cellulosic material, preferably two or three layers of cellulosic material, to form a second seal, or combinations thereof.

In a second aspect, the present disclosure relates to a process of sealing packaging parts, the process comprising the following steps: a) providing a cylindrical container (10) comprising a body portion (50) and one or two opened ends (30,40), and providing one or two closures (34, 93), wherein the closures (34, 93) each comprise a flange (94) at their perimetral rim; b) positioning the closures (34, 93) so that the flange (94) is in perimetral contact with the opened ends (30, 40); c) positioning a sonotrode (500), so that i) the sonotrode (500) is in contact with the closures (34, 93), with the ends (30, 40), or combinations thereof, or ii) the sonotrode (500) is at a distance from the closures (34, 93), from the ends (30, 40), or combinations thereof, so that, upon oscillation of the sonotrode (500), the sonotrode (500) contacts the closures (34, 93), the ends (30, 40), or combinations thereof; and d) oscillating the sonotrode (500) to ultrasonically seal the flange (94) to the respective end (30, 40) to form a seal, optionally wherein the process is used to make the products of claim 1-6.

In a third aspect, the present disclosure relates to a process for making a packaged product comprising a cylindrical container (10) according to claims 1-6 and a laundry composition (270), the process comprising the following steps: a) obtaining the cylindrical container (10), wherein the cylindrical container (10) comprises a body portion (50) having a closed first end (30) and an open upper end, wherein the first end (30) comprises a first closure (34); b) filling the cylindrical container (10) with the laundry composition (270) through the open upper end; and c) applying a removeable lid (90) to the open upper end of the cylindrical container (10), wherein the removable lid (90) comprises a second closure (93) and a lid wall (92), wherein the cylindrical container (10) and the removable lid (90) comprise cellulosic material, wherein the first closure (34) is sealed to the first end (30) by ultrasonic sealing, wherein the ultrasonic sealing seals a plurality of layers of cellulosic material, preferably two layers of cellulosic material, to form a first seal, or wherein the second closure (93) is sealed to the lid wall (92) in a second end (40) by ultrasonic sealing, wherein the ultrasonic sealing seals a plurality of layers of cellulosic material, preferably two layers of cellulosic material, to form a second seal, or combinations thereof.

### BRIEF DESCRIPTION OF THE DRAWINGS

FIG. 1. An unopened container.

FIG. 2. An opened container in which the predetermined removeable portion, cap portion, and predetermined removable portion are separated from one another.

FIG. 3. A reclosed container in which the cap portion is fitted over the lobes.

FIG. 4. A partial view as indicated in FIG. 3.

FIG. 5A. A cross-sectional view of the lid of a container.

FIG. 5B. A cross-sectional view of the bottom of a container.

FIG. 6. An unopened container.

FIG. 7. An opened container.

FIG. 8. A partial view of a predetermined removable portion.

FIG. 9. A partial view of a predetermined removable portion.

FIG. 10. A blank for constructing a container.

FIG. 11. A blank for constructing a container.

FIG. 12. A top view of an opened container.

FIG. 13. A top view of an opened container.

FIG. 14. A blank for constructing a container.

FIG. 15A. A cross-sectional view of the lid of a container and a sonotrode.

FIG. 15B. A cross-sectional view of the bottom of a container and a sonotrode.

### DETAILED DESCRIPTION

It was surprisingly found that, carton cylindrical containers sealed by ultrasonic sealing, have less structural weaknesses and are more resistant to leakage and tampering, ensuring the integrity of the packaged products.

In a first aspect, the present disclosure relates to a cylindrical container (10) comprising cellulosic material, wherein the cylindrical container (10) comprises a body portion (50) having a first end (30) and a second end (40), wherein the first end (30) comprises a first closure (34) and the second end (40) comprises a second closure (93), wherein the first closure (34) is sealed to the first end (30), wherein the second closure (93) and a lid wall (92) are part of a removeable lid (90), wherein the second closure (93) is sealed to the lid wall (92) in the second end (40), wherein the removable lid (90) comprises cellulosic material, characterised in that the first closure (34) is sealed to the first end (30) by ultrasonic sealing, wherein the ultrasonic sealing seals a plurality of layers of cellulosic material, preferably two or three layers of cellulosic material, to form a first seal, or wherein the second closure (93) is sealed to the lid wall (92) by ultrasonic sealing, wherein the ultrasonic sealing seals a plurality of layers of cellulosic material, preferably two or three layers of cellulosic material, to form a second seal, or combinations thereof.

Without wishing to be bound by theory, sealing a plurality of cellulosic layers by ultrasonic sealing provides better seal integrity and reduces structural weaknesses over time compared to seals formed by hot air or glue.

In one aspect, the ultrasonic sealing may seal two layers of cellulosic material to form each of the first seal and/or the second seal.

In a preferred aspect, the first seal, the second seal, or combinations thereof, each have two layers of cellulosic material sealed together by ultrasonic sealing, and one additional unsealed layer of cellulosic material, wherein the one additional unsealed layer of cellulosic material is the most external layer of cellulosic material in the seal.

By the most external layer, it is herein intended the layer that is the farthest away from the internal compartment of the cylindrical packaging or from the centre point of the closures (34,93).

Without wishing to be bound by theory, sealing the two internal layers by ultrasonic sealing is sufficient to create strong seals, while the external layer provides stability to the seal. Sealing the internal layers by ultrasonic sealing also provides a surprising benefit compared to seals provided by hot air. Hot air is commonly applied form the lateral sides of the container, thus only sealing the two external layers of the seal. The third internal layer remains unsealed or partially sealed, resulting in a structural weakness often leading to a “raised lip” upon use of the container by the consumer. The “raised lip” problem is solved by the cylindrical container according to the present disclosure.

In another aspect, the ultrasonic sealing may seal three layers of cellulosic material to form each of the first seal and/or the second seal. It is believed that a seal where three layers are sealed by ultrasonic sealing provides for a particularly strong seal with less structural weaknesses.

In another aspect, the ultrasonic sealing may seal three or more layers of cellulosic material to form each of the first seal and/or the second seal.

For clarity, the bottom disk is represented by the first closure 34, which is sealed to the first end 30 of the cylindrical container 10. On the other hand, the lid is represented by the removable lid 90, which is formed by ultrasonically sealing the top disk, i.e. the second closure 93, to the lid wall 92 in the second end (40) of the body portion (50). The removable lid 90 thus created, may be removably mounted on the open upper end of the open cylindrical container 10. The upper limit of the lid wall 92 corresponds with the second end (40) of the body portion (50) when the lid is not detached from the cylindrical container 10.

### Cylindrical Container

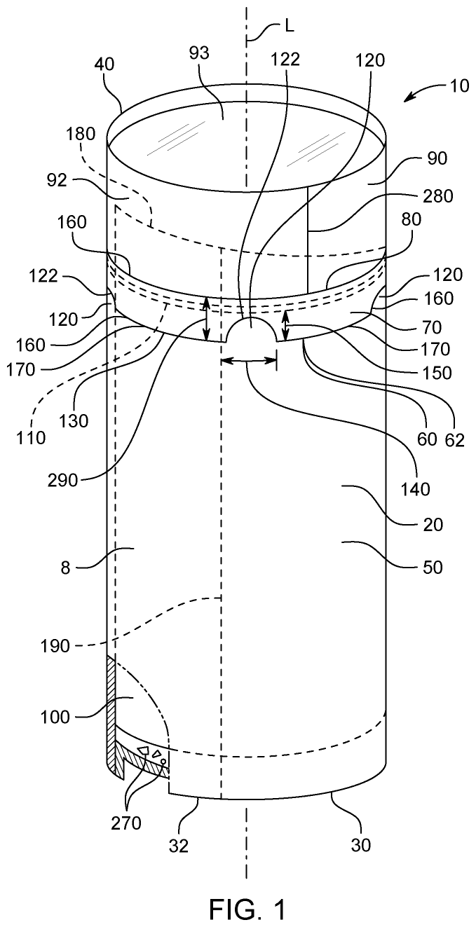

A container 10 having aspects as those described herein is shown in FIG. 1. The container 10 can have paperboard shell layer 20 a longitudinal axis L. The container 10 can have a height along the longitudinal axis from 50 mm to 600 mm, optionally from 50 mm to 200 mm. The area of the container 10 orthogonal to the longitudinal axis L can be from 10 cm² to 300 cm², optionally from 30 cm² to 100 cm². The interior volume of the container can be from 100 mL to 2 L, optionally from 300 mL to 1600 mL.

The container 10 can have a base 32 upon which the container 10 is designed to rest. The container base 32 can have a maximum external dimension from 5 cm to 50 cm. A cylindrical container 10 may have a container base having an exterior diameter from 5 cm to 50 cm. A cylindrical container 10 having an exterior diameter from 5 cm to 20 cm, optionally from 5 cm to 10 cm, can be practical. A container 10 having an exterior diameter from 5 cm to 20 cm, or even from 5 cm to 18 cm, can be conveniently gripped by a user. The container 10 shown in FIG. 1 is a hollow right circular cylinder having closed ends. By cylindrical container, a cylinder with circular, oval or elliptical section is meant.

The paperboard shell layer 20 and the paperboard core layer 100 can individually have a basis weight greater than 250 g/m², optionally from 250 g/m² to 800 g/m². The paperboard can be single-or multi-ply. The paperboard shell layer 20 and paperboard core layer 100 can each have a thickness from 0.3 mm to 2 mm. The paperboard core layer 100 and paperboard shell layer 20 can be coated with a substance so that the material is printable, to protect the contents of the container 10, protect the paperboard materials of the container 10 from the contents, or to provide a ultrasonically-sealable or heat-sealable layer. For example, a sealable layer or coating can be provided on the surface of the paperboard shell layer 20 oriented towards the longitudinal axis L and the surface of the paperboard shell layer 20 oriented away from the longitudinal axis L. Such coatings or layers can help provide for sealing the paperboard shell layer 20 along the longitudinal seam 230. A coating or layer to provide for sealing or heat sealing can be provided only at locations proximal the longitudinal seam 230. Ink and or varnish may be applied to the paperboard materials on one or both of the surface facing away from the longitudinal axis L or the surface facing towards the longitudinal axis L.

The terms ‘paper board’ and ‘carton’ are used interchangeably in the present application. Both materials are deemed to be made in whole or partially from cellulosic material and/or fibrous cellulosic material. Fibrous cellulose material can be virgin, recycled, or a mixture thereof. Cellulose materials may be obtained from hardwood, softwood, or other natural renewable resources for fibers. Fibrous cellulose material can be obtained from bamboo, wheat straw, bulrush, com, rice husk, sugar cane, grass fiber, or from recycled paper and paperboard.

The cellulose layers described herein are meant as layers comprising cellulose. The cellulose layers may comprise additional components, e.g. heat-sealant coatings such as polyethylene coatings. Such coatings can be applied to the internal or external sides of said cellulose layers or being integrated/intermixed with the cellulose fibers. Glues are not necessary as sealant in the seals where the ultrasonic sealing is used. However, glues may be additionally present on the cellulosic material. In one aspect, the heat-sealant coatings may additionally comprise glues, e.g. dry glue beads, participating to the sealing of cellulosic layers by the ultrasonic sealing.

In one aspect, the cellulosic layers may comprise heat-sealant coatings.

In one aspect, at least two, preferably two or three, layers of cellulosic material may comprise heat-sealant coatings, wherein at least two adjacent heat-sealant coatings are sealed together by the ultrasonic sealing, preferably, wherein the heat-sealant coating is a polymeric heat-sealant coating, more preferably a plastic heat-sealant coating, most preferably a polyethylene heat-sealant coating. It is believed that, polyethylene coatings are advantageous to melt and seal rapidly with ultrasonic sealing and create particularly strong seals.

The exterior and or interior surfaces of the container 10 can be coated with a natural or polymeric coating, by way of nonlimiting example, polyethylene, polyethylene terephthalate, or polypropylene, to provide a moisture barrier. Coatings of wax, clay, starch, kaolin, polyethylene terephthalate, polypropylene, polylactic acid, silicates, ethylene vinyl alcohol, polyvinyl alcohol, and other natural and or biodegradable coatings that adequately provide a barrier against moisture and or oxygen and or fragrance migration into or out of the container 10 can be useful. The core layer 100 can be a spiral wound paperboard material that is cut to an appropriate length and has an outer diameter that is closely conforming to the interior surface of the shell layer 20. The core layer 100 can be wrapped around a mandrel to form a cylindrical container having the appropriate length.

The shell layer 20 can extend from the first end 30 to a second end 40. The first end 30 comprises the shell bottom edge of the container 10. The second end 40 comprises the top shell edge. The shell layer 20 can form the majority of the container 10. The shell layer 20 can form the outside or exterior surface of the container 10.

The shell layer 20 can comprise a body portion 50. The body portion 50 forms at least part of the lower portion 8 of the container 10. The body portion 50 can extend from the first end 30 to a lower line of limitation 60. The first end 30 can be the part of the container 10 upon which the container 10 is designed to sit when placed on a flat surface.

The lower line of limitation 60 can define the upper boundary 62 of the body portion 50. A predetermined removable portion 70 can extend from the lower line of limitation 60 to an upper line of limitation 80. The predetermined removable portion 70 can extend the longitudinal axis L, partially, substantially, or completely. The predetermined removable portion 70 can extend the longitudinal axis except at the longitudinal seam 230. The lower line of limitation 60 and upper line of limitation 80 can each be a line of frangibility 160 around or partially around the longitudinal axis L. The line of frangibility 160 can be perforations, partial cuts, or weakened portions of the shell layer 20. The line of frangibility 160 can be a structure that can be manually tom by the user in a controllable manner along a predetermined path around or partially around the longitudinal axis L of the container 10. For example, the line of frangibility 160 can be a series of intermittent through cuts, a series of score cuts, a series of perforations from which material has been removed, a score line, a partial die cut, partial die cuts on opposing surfaces, offset partial die cuts on opposing surfaces, a zipper die cut, or the like.

The line of frangibility 160 can be reinforced with a tape that is applied to the inside of the shell layer 20. Polyethylene, polypropylene, or polyethylene terephthalate tape applied to the shell layer 20 can help guide tearing and prevent unintentional breakage of the line of frangibility 160. The line of frangibility 160 can be defined by a plurality of structural disruptions of the shell layer 20 spaced apart from one another. A lobe 120 can be defined by more than two structural disruptions. The structural disruptions can be selected from the group consisting of through cuts, score cuts, through die continuous cuts, partial die continuous cut, partial die cuts, zipper die cuts, reversed partial die continuous cut, reversed partial die interrupted cut, perforations from which material has been removed, laser cut, and combinations thereof.

The upper line of limitation 80 can be orthogonal to the longitudinal axis L. A straight upper line of limitation 80 can be easy for the user of the container 10 to tear when the container 10 is being opened. Furthermore, a straight upper line of limitation 80 can provide for a removable lid 90 that has straight lip and is convenient to use as a dispensing and or dosing cap.

When the container 10 is in an unopened condition, predetermined removable portion 70 connects the body portion 50 to the removable lid 90. The removable lid 90 extends from the upper line of limitation 80 to the second end 40. The removable lid 90 can form at least part of the upper portion 9 of the container 10. The container 10 can be prepared to open for the first time by removing the predetermined removable portion 70 from the container 10. A tear strip 110 engaged with the predetermined removable portion 70 and positioned between the predetermined removable portion 70 and the core layer 100 can be provided to assist the user with tearing the predetermined removable portion 70 from the container 10. Once the predetermined removable portion 70 is removed from the container 10, the removable lid 90 can be separated from the body portion 50 by the user to access the contents of the container 10.

The container 10 can further comprise second closure 93. The second closure 93 can form a closed end of the removable lid 90. The second closure is intended to be the cap end of the container 10. The second closure 93 can close off the top of the container 10, the top of the container 10 being the end of the container associated with the removable lid 90. The second closure 93 can be a separate piece of paperboard fitted with the removable lid 90 near the second end 40. Optionally, the second closure 93 can be a flap or flaps of paperboard that are integral extensions of the removable lid 90 that are folded to form the second closure 93.

To provide for a container 10 that is easily opened and reclosed, it can be practical to provide for a core layer 100 extending at least partially the longitudinal axis L and interior to the shell layer 20. The core layer 100 can be described as being between the shell layer 20 and the longitudinal axis L. Once the container 10 is opened, the core layer 100 can provide for structure that can guide fitting of the removable lid 90 to one or more parts of the body portion 50 to reclose the container 10.

The core layer 100 can be joined to the body portion 50. The core layer 100 can be joined to the body portion 50 below the lower line of limitation and not above the lower line of limitation. The core layer 100 can be joined to the body portion 50 only at locations below the lower line of limitation. The core layer 100 and the body portion 50 can be glued, taped, or heat sealed otherwise bonded to one another to join the two parts. The glue can be a hotmelt, cold glue, or pressure sensitive glue. The core layer 100 can extend from below the lower line of limitation 60 to above the upper line of limitation 80. The removable lid 90 can be unaffixed to the core layer 100 above the lower line of limitation 60. The removable lid 90 can be unaffixed to the core layer 100 above the optional tear strip 110. The removable lid 90 can be unaffixed to the core layer 100 above the predetermine removeable portion 70. Being in such an unaffixed state can make the removable lid 90 easy to twist and or slide off of the core layer 100 to remove the removable lid 90 from the body portion.

Optionally, the container 10 can comprise a tear strip 110 between the predetermined removable portion 70 and the core layer 100 and extends around or at least partially the longitudinal axis L. The tear strip 110 can be joined to the predetermined removeable portion 70. The tear strip 110 can be a piece of adhesive tape adhered to the shell layer 20. The backing layer of the adhesive tape can be polyethylene, polypropylene, oriented polypropylene, polyethylene terephthalate, polyamide, nylon, or other polymers, yams, and filaments. The adhesive layer of the adhesive tape can be a pressure sensitive glue, heat sensitive glue, solvent or water based adhesive, or similar. The tear strip 110 can help to controllably transmit user applied tearing force to the predetermined removeable portion 70 so that the predetermined removable portion 70 is controllably torn from the shell layer 20.

To open the container 10, the user can pull on the tear strip 110 or a free end of the predetermined removeable portion 70 to initiate tearing of the predetermined removeable portion 70 from the body portion 50 and the removable lid 90. The tearing can occur along or near each of the lower line of limitation 60 and the upper line of limitation 80 along the respective lines of frangibility 160. Once the predetermined removeable portion 70 is removed from the container 10, the removable lid 90 can be easily removed from the body portion 50 to access the contents of the container 10. Once the removable lid 90 is removed, the contents of the container 10 can be dispensed and or measured into the removable lid 90 and used in a directed manner. The removable lid 90 can be used as a dosing cup for household products, a serving cup for food products, a measuring cup for consumable dry goods, or similar use.

There are some types of paperboard containers that have been designed to provide for convenient opening. Unfortunately, designs of paperboard containers that are easy to open are often difficult to securely close. For example, paperboard cereal and pasta containers are notorious for being difficult to securely close and the contents of containers like these are frequently spilled when the container tips over as the user pulls out a drawer from a pantry or accidentally bumps a container on a shelf or countertop.

The container 10 may contain from 50 g to 1500 g of laundry composition 270. After first opening the container 10 to use the contents of the container 10, the user may desire to securely close the container 10. That way, if the container 10 is accidentally tipped over or inverted, the contents of the container 10 will not spill out. A face to face frictional engagement between the lid wall interior facing surface and the core layer 100 that sticks up above the lower line of limitation 60 may not be sufficient to maintain the container 10 in a reclosed condition, particularly if the contents of the container 10 are heavy. This may be because the coefficient of friction between typical paperboard materials is low and the removable lid 90 may not be able to apply a high enough normal stress since the removable lid 90 may relax to some degree after being fitted over the core layer 100. To that end, a mechanism for more securely reclosing the container 10 may be desirable. A mechanism based on one or more wedges may be practical.

To provide for a sufficiently secure closure mechanism for a container 10 as described herein, the body portion 50 of the container 10 can comprise a lobe 120 immediately below the lower line of limitation 60. The shape of the lobe 120 per se can be defined by the lower line of limitation 60. That is, the lower line of limitation 60 can form the upper boundary 62 of the body portion. A lobe 120 is a flap or projection of the of the body portion 50 that extends higher up on the core layer 100, that is be longitudinally more extensive, than parts of the body portion 50 adjacent to the lobe 120.

Once the removable lid 90 is removed from the body portion 50, the user may desire to reclose the container 10 by placing the removable lid 90 back on the body portion 50. The core layer 100 can be a guide for fitting the removable lid 90 onto the body portion 50. The lobe 120 can function as a wedge to provide for mechanical engagement of the removable lid 90 to the body portion 50 when the container is reclosed. The removable lid 90 has the same peripheral shape as the body portion 50 and may need to be deformed or stretched to fit over the lobe 120.

The body portion 50 can have a peripheral exterior length 130 orthogonally the longitudinal axis L immediately below the lobe or lobes 120. If the container 10 has a shape of a right circular cylinder, the peripheral exterior length 130 is the circumference of the outer surface of the container 10 immediately below the lobe or lobes 120. If multiple lobes 120 are provided, then the peripheral exterior length 130 is measured immediately below the lobe 120 that is closest to the first end 30 of the container 10. The peripheral exterior length 130 is a scalar quantity. The peripheral exterior length 130 can be from 10 cm to 70 cm. The peripheral exterior length 130 can be from 20 cm to 40 cm.

Each lobe 120 can have a lobe exterior height 150 parallel to the longitudinal axis L. The lobe exterior height 150 is the maximum dimension of the lobe 120 measured parallel to the longitudinal axis L and the datum from which the lobe exterior height 150 is measured is a line that connects the ends of the lobe 120 being measured. For semicircular or semi-oval lobes 120, the lobe exterior height 150 is the radius of the semicircle. Lobes 120 adjacent to one another can have lobe exterior heights 150 that vary from one another. Such lobes 120 having a staggered lobe exterior height 150 may provide for variable engagement of the removable lid 90 with the body portion 50 depending on how far down the removable lid 90 is pushed towards the body portion 50. The lobe exterior height 150 is a scalar quantity. The lobe exterior height can be from 1 mm to 30 mm.

Each lobe 120 can have a curved upper contour 122. A curved upper contour 122 may be easier to tear along as compared to an upper contour 122 comprising straight segments. Further a curved upper contour 122 may be easier to engage with the removable lid 90 once the container 10 is opened and then the removable lid 90 is used to close the container 10. The curved upper contour 122 may provide for a gradual engagement or wedging of the removable lid 90 to the body portion 50. As the user deforms the removable lid 90 to fit over the lobe or lobes 120, the rounded or curved upper contour 122 provides for gradual engagement of the removable lid 90 with the lobe or lobes 120 so that the lobe or lobes 120 can be gently wedged between the removable lid 90 and the core layer 100.

Each lobe 120 can have a lobe exterior length 140 orthogonal to or the longitudinal axis L. If the body portion 50 is cylindrical, the lobe exterior length 140 is measured on the exterior surface of the body portion 50 and along the part of the circumference of the body portion 50 where the lobe 120 being characterized is present. Portions of a lobe 120 may reside on adjacent faces of the body portion 50.

The lobe exterior length 140 can be more than 5% of the peripheral exterior length, optionally more than 10% of the peripheral exterior length, optionally from 5% of the peripheral length to 30% of the peripheral length, optionally from 5% of the peripheral length to 20% of the peripheral length, optionally from 10% of the peripheral length to 25% of the peripheral length. The lobe exterior length 140 can be from 1 mm to 60 mm. Each lobe 120 can have a lobe exterior length 140 to lobe exterior height 150 greater than 1. Lobes 120 having such aspect ratio can provide for a predetermined removeable portion 70 that can be easily separated from the body portion 50 of the container 10. As the predetermined removable portion 70 is removed by pulling on the predetermined removeable portion 70 and tearing the predetermined removeable portion 70 along the upper line of limitation 80 and lower line of limitation 60, the limited directional variation of the lower line of limitation 60 reduces the potential for the tear line to deviate from the lower line of limitation 60. Taller lobes 120 or a lower line of limitation 60 that has vertices or abrupt changes in direction may result in the tear line not optimally following the lower line of limitation 60 when the predetermined removable portion 70 is removed.

The body portion 50 can comprise a plurality of lobes 120. For example, the body portion 50 can comprise two lobes 120. The two lobes 120 can be spaced apart from one another by straight segments 170 of the lower line of limitation 60. Optionally, the two lobes 120 can be on opposite sides of the longitudinal axis L. Optionally, the body portion 50 can comprise three or four lobes 120 spaced apart the longitudinal axis L, optionally evenly spaced apart the longitudinal axis L. The lobes 120 can be spaced apart from one another by from 10% to 80% of the peripheral exterior length 130. Such spacing can be practical for providing room for the removable lid 90 to be deformed to wedge fit over the lobes 120 when the removable lid is reengaged with the body portion 50 after the container is opened. The lobes 120 can be spaced apart from one another by 1 mm to 350 mm, optionally from 10 mm to 100 mm, optionally from 20 mm to 80 mm.

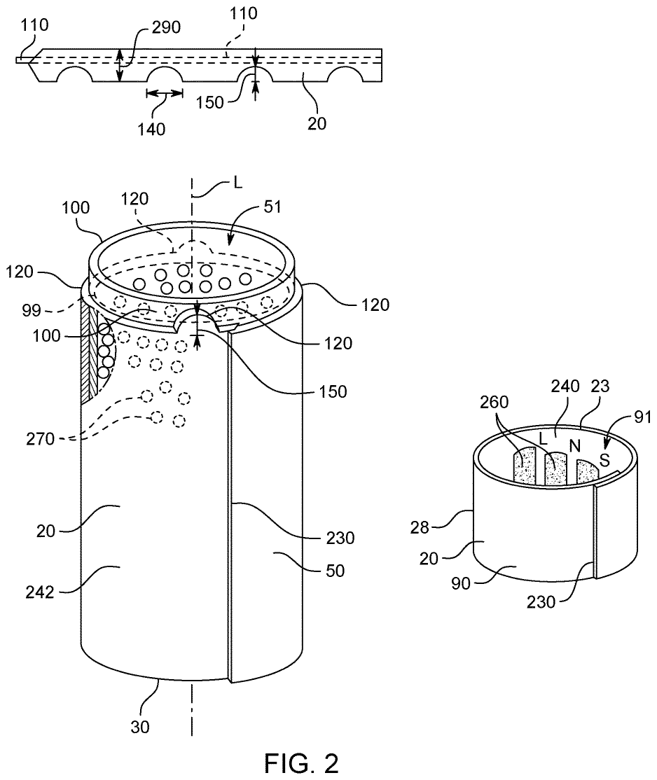

An open container 10 is shown in FIG. 2. In FIG. 2, the predetermined removable portion 70 is separated from the removable lid 90 and the body portion 50. The user of the container 10 can place the predetermined removable portion 70 in a recycling collection bin or waste bin. The core layer 100 can extend above the upper line of limitation 80. The core layer 100 can extend above the upper line of limitation 80 by more than 5% of the peripheral exterior length 130, optionally from 5% of the peripheral exterior length to 50%, optionally from 5% of the peripheral exterior length to 30%, of the peripheral exterior length. Such an arrangement provides for a core layer 100 that can support the lobes 120 when the removable lid 90 is fitted onto the body portion 90 to close the container 10 after opening.

The core layer 100 can be discontinuous the longitudinal axis L. This can simplify erection of the container 10 since the vertical edges of the core layer 100 need not be precisely fitted to and joined to one another.

Before the container 10 is first opened, the removable lid 90 is part of shell layer 20. The shell layer 20 can have an interior facing surface 240 oriented towards the longitudinal axis L and an opposing exterior facing surface 242. The interior facing surface 240 above the lower line of limitation 60 can comprise the at least one dosing indicia 260.

The removable lid interior 91 can have a removable lid interior volume from 10 mL to 400 mL. The container 10 can have an body portion interior 51 and the body portion interior volume from the first closure 34 to the upper line of limitation 80 can be from 50 mL to 2000 mL. The first closure 34 is intended to be the bottom end of the container 10. The removable lid interior volume can be from 0.5 to 50% of the body portion interior volume. That arrangement can provide for a container 10 that contains from 1 to 80, optionally from 18 to 20, doses of laundry composition 270.

The laundry composition 270 in the container can be filled to a fill level 99. The fill level 99 can be below the core rim 180. Such an arrangement can be practical if the laundry composition 270 have a propensity to fall out of the lower part of the container 10 when the container 10 is opened in an upright position. Laundry compositions 270 that are particles may have a such a propensity to spill out of the container 10 upon opening. The fill level 99 can be below the upper line of limitation 80. That fill level can reduce the potential for accidental spilling of the laundry composition 270 from the container 10 as the container 10 is opened.

In a formed container 10, the shell layer 20 can comprise a longitudinal seam 230 extending at least partway between the first end 30 and the second end 40, optionally extending from the first end 30 to the second end 40 excluding the predetermined removable portion 70. The longitudinal seam 230 can be a butt seam or overlapping seam and comprise a glue or tape, or be heat sealed to help maintain integrity of the longitudinal seam 230.

The longitudinal seam 230 can be glued, taped, or heat sealed at spaced apart locations along the longitudinal seam 230. The longitudinal seam 230 can be a flange seam in which both edges of the shell layer 20 along the longitudinal axis L each have a flange and the flanges are joined to one another. The flange seal can be tucked towards the interior of the container 10 or be oriented outwardly from the container 10 with tucking towards the interior of the container 10 being more discrete. The flanges of the flange seal constituting the longitudinal seam 230 can be glued, or taped, or heat sealed to one another.

The removable lid 90 can have a removable lid height 280 measured parallel to the longitudinal axis L between the upper line of limitation 80 and the second end 40. The predetermined removeable portion 70 can have a predetermined removeable portion maximum height 290 measured parallel to the longitudinal axis L. The predetermined removeable portion maximum height 290 is measured at an appropriate location which will be away from a lobe 120. The removable lid height 280 can be greater than the predetermined removable portion height 290. Such an arrangement can provide for a removable lid 90 that can be fully fitted over the core layer 20 to close the container 10 after opening.

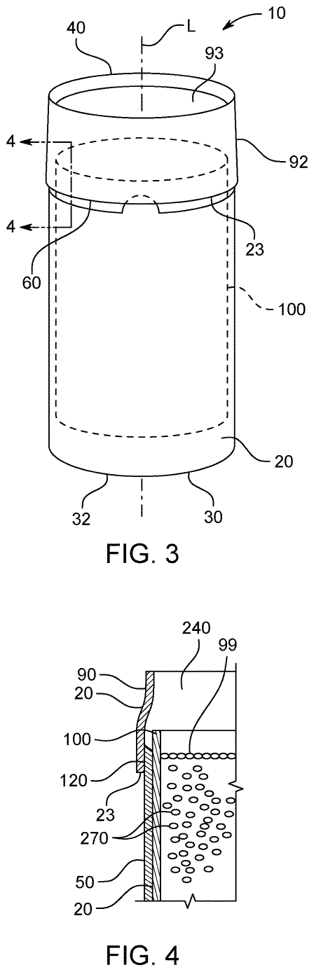

The user opens the container 10 by removing the predetermined removable portion 70 from the container 10. The removable lid 90 is then separated from the body portion 90 so that the user can access the contents of the container 10. After a portion of the contents of the container 10 have been dispensed, the user can reclose the container 10, for example as shown in FIG. 3.

As shown in FIG. 3, the lid wall interior facing surface 240 is oriented towards the longitudinal axis L. The lobe 120 or lobes 120 can be wedged between the lid wall interior facing surface 240 and the core layer 100. As described herein, the removable lid 90 and body portion 50 are formed from the shell layer 20. The lobes 120 are integral extensions of the body portion 50. As such, the removable lid 90 cannot fit over the lobes 120 unless the lip 23 of the removable lid 90 is deformed to fit or slide over the lobes 120. For a cylindrical removable lid 90, user can gently squeeze the lid wall 92 on opposing sides which results in hoop stress being applied to lid wall 92. The deformation of the lid wall 92 in such manner can provide for room for portions of the lid wall 92 away from the location that the squeezing forces are applied to deform away from the longitudinal axis L and be slid over the lobe 120 or lobes 120. Once the hoop stress is relieved by the user ceasing to squeeze the lid wall 92, the lid wall 92 relaxes and leaves the lobe 120 or lobes 120 wedged between the core layer 100 and the lid wall interior facing surface 240. The frictional fit and wedging of the removable lid 90 to the body portion 50 can help securely close the container 10. The frictional fit and wedging, provides a resistance force in the direction of the longitudinal axis L when the removable lid 90 is pulled away from the body portion 50 or pushed away from the body portion 50 by the contents of the container 10 if the closed container 10 is tipped over sideways or inverted.

In FIG. 4, a partial cross sectional view of a container 10 is shown that has been first opened by removing the predetermined removable portion 70 and separating the removable lid 90 and then reclosed by replacing the removable lid 90 onto the body portion 50. As shown in FIG. 4, the removable lid 90 can be deformed to be fitted over the lobe 120. The lobe 120 is wedged between the lid wall interior facing surface 240 and the core layer 100.

The body portion 50 can be provided with one or more lobes 120. When only a single lobe 120 is provided, the reclosed removable lid 90 may be fitted over the lobe 120 and the interior facing surface 240 of the core layer 100 opposite to the location of the lobe 120 may be in contact with the core layer 100. The wedging of the lobe 120 in between the removable lid 100 and core layer 100 plus the frictional engagement between the interior facing surface 240 of the removable lid 90 and the core layer 100 opposite the lobe 120 can be sufficient to reasonably securely maintain the container 10 in a closed condition after the container 10 has been first opened.

A plurality of lobes 120 can provide additional wedging locations to more securely close a previously opened container 10. Two lobes 120 can be advantageously positioned on opposite sides of the longitudinal axis L. In that arrangement, the user can gently pinch the lip 23 between his or her thumb and forefinger, for example at a 12 o'clock and 6 o'clock positions, to deform the lip 23 so that locations positions at the 3 o'clock and 9 o'clock positions along the lip 23 are outwardly deformed and can be slide over the lobes 120.

Four lobes 120 can be advantageously evenly spaced out at the 1:30 o'clock, 4:30 o'clock, 7:30 o'clock, and 10:30 o'clock position on the body portion 50. The user can gently pinch the lip 23 at the 12 o'clock and 6 o'clock positions to deform the lip 23 so that the locations along the lip 23 corresponding the lobes 120 are deformed to fit over the four lobes 120.

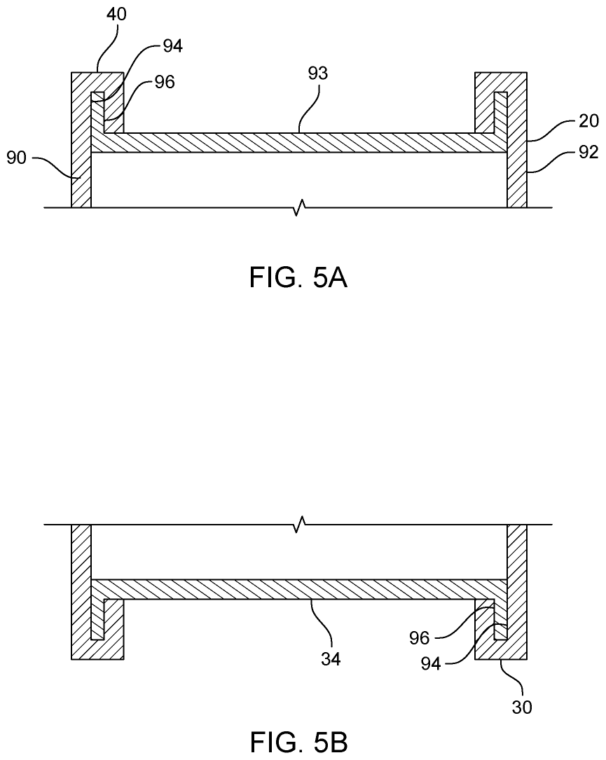

The second closure 93 can be an insert in the top of the container 10, as shown in FIG. 5A. The second closure 93 can be paperboard or corrugate. The second closure 93 can comprise a flange 94 peripherally extending from the second closure 93. The flange 94 can be glued, taped, heat sealed, ultrasonically sealed to the interior facing surface 240 of the removable lid 90 (i.e. the internal side of the second end 40 of the body portion 50), preferably ultrasonically sealed. The flange 94 may be tucked within a folded extension 96 integrally extending from the second end 40 of the body portion 50. The folded extension 96 can be glued, taped, heat sealed, ultrasonically sealed to the flange 94, preferably ultrasonically sealed. And the flange 94 can optionally be glued, taped, heat sealed, ultrasonically sealed to the interior facing surface 240 of the removable lid 90, preferably ultrasonically sealed.

A similar construct can be provided to form the first closure 34, as shown in FIG. 5B. The first closure 34 can comprise a flange 94 peripherally extending from the first closure 34. The flange 94 can be glued, taped, heat sealed, ultrasonically sealed to the interior facing surface 240 of the body portion 50 (i.e. the internal side of the first end 30 of the body portion 50), preferably ultrasonically sealed. The flange 94 may be tucked within a folded extension 96 integrally extending from the first end 30 of the body portion 50. The folded extension 96 can be glued, taped, heat sealed, ultrasonically sealed to the flange 94, preferably ultrasonically sealed.

The flange 94 can optionally be glued, taped, heat sealed, ultrasonically sealed to the interior facing surface 240 of the body portion 50, preferably ultrasonically sealed. Employing a folded extension 96 within which the flange 94 is positioned between opposing parts of the folded extension 96 and glued, taped, heat sealed, ultrasonically sealed to the folded extension 96 can provide for a sturdy container 10, especially when ultrasonically sealed. A cold, hotmelt, or pressure sensitive glue or a heat seal or tape or other bond can be used to join the second closure 93 to the shell layer 20.

In a preferred aspect, the first closure (34), the second closure (93), or combinations thereof, may each comprise a flange (94) at their perimetral rim, wherein the flange (94) may have a surface forming an angle (503) of between 45° and 135°, preferably between 70° and 110°, more preferably between 80° and 100°, with the surface of the respective closure (34, 93), wherein the first seal, the second seal, or combinations thereof, may each comprise the respective flange 94 tucked in between the respective end (30,40) of the body portion (50) and a folded extension 96 integrally extending from the respective end (30,40) of the body portion 50, wherein the folded extension (96) may be substantially parallel to the flange (94).

By substantially parallel or substantially perpendicular, we herein mean within an angle deviation from parallelism of +/−20°, preferably +/−10°, more preferably +/−5°, most preferably +/−1°.

It is believed that, a three-layered system of this type creates a stable junction on the top and/or bottom disk of a cylindrical packaging which can be subject to either a double-layer or a triple-layer sealing by ultrasonic sealing.

In another preferred aspect, the internal side of the respective end (30,40) of the body portion (50) and the external side of the flange (94) may be sealed, or the internal side of the flange (94) and the external side of the folded extension (96) may be sealed, or combinations thereof, preferably the internal side of the flange (94) and the external side of the folded extension (96) may be sealed.

By internal side, it is herein intended the side facing inward (i.e. towards the centre point of the closures (34,93)). By external side, it is herein intended the side facing outward (i.e. facing away from the cylindrical packaging (34,93)).

It is believed that, a double-layer seal, especially on the two internal layers, is particularly advantageous for creating a strong seal, while also solving the “raised lip” problem.

In another preferred aspect, at least a portion of the internal side of the respective end (30,40) of the body portion (50) and of the external side of the flange (94) may comprise a heat-sealant coating associated to the cellulosic layers, wherein the heat-sealant coatings are sealed together by the ultrasonic sealing, or at least a portion of the internal side of the flange (94) and the external side of the folded extension (96) comprise a heat-sealant coating associated to the cellulosic layers, wherein the heat-sealant coatings are sealed together by the ultrasonic sealing, or combinations thereof, preferably, wherein the heat-sealant coating is a polymeric heat-sealant coating, more preferably a plastic heat-sealant coating, most preferably a polyethylene heat-sealant coating.

It is believed that, sealing of two adjacent heat sealant coatings, especially when the heat sealant coatings are on the sides of the cellulosic layers, is particularly advantageous.

In a preferred aspect, the cylindrical container (10) houses a laundry composition (270), wherein the laundry composition (270) is selected from a granular laundry composition, a liquid laundry composition, a single unit-dose laundry composition or mixtures thereof, preferably a granular laundry composition, more preferably wherein the laundry composition (270) has a mass of less than 1500 g, preferably between 100 g and 600 g, more preferably between 400g and 600g.

Without wishing to be bound by theory, the strong seals formed by ultrasonic sealing can withstand heavier loads of product, i.e. resulting in a cylindrical container with resistance to external forces, e.g. consumer (mis)handling as well as internal forces, e.g. pressure exerted by the laundry composition (270).

The container 10 can be a closed ended container. The second end 40 can be closed by a second closure 93. The first end 30 can be closed by a first closure 34. The second closure 93 can be opposite the first closure 34. The second closure 93 can be proximal the second end 40 and form a closed end at the second end 40. The first closure 34 can be proximal the first end 30 and form a closed end at the first end 30.

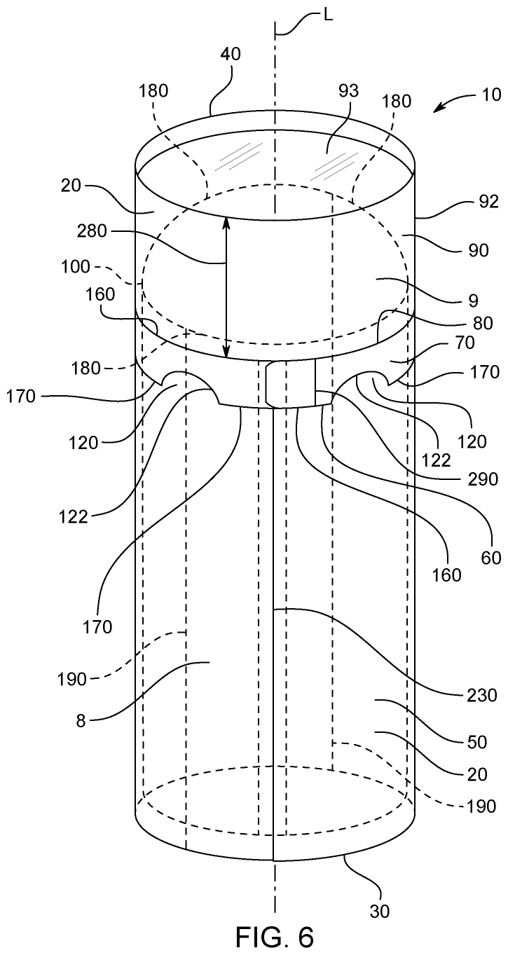

As shown in FIG. 6, the container 10 can be provided with a structure that can provide for convenient dispensing of the contents from the container 10. The core layer 100 can extend to a core rim 180 above the upper line of limitation 80. In this arrangement, the core layer 100 can provide for back support of the lobe or lobes 120 when they are employed to securely reclose the container 10. The core rim 180 can be below the second end 40 so that the removable lid 90 can fit over the core layer 100.

A simple construction of the container 10 is one in which longitudinal seam 230 is nearer to a low point of the core rim 180 than the high point of the core rim 180, as that may simplify layout of the blank from which the container 10 is erected. The core rim 180 is located at a rim distance 190 from the first end 30 as measured parallel to the longitudinal axis L. The rim distance 190 can be a function of position the longitudinal axis L.

A container 10 in which the rim distance 190 is not a function of position the longitudinal axis L is shown in FIG. 2. For the container 10 shown in FIG. 2, the rim distance 190 is constant. Including a non-flat contour to the core 180 can provide for convenient dispensing of the contents of the container 10.

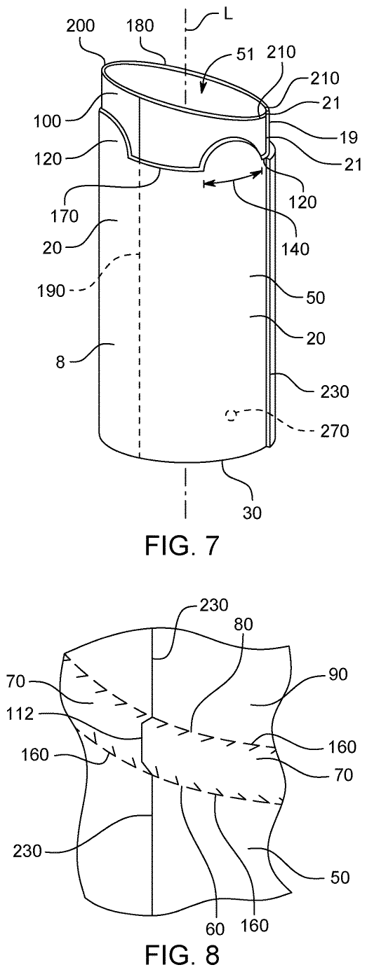

The core rim 180 can have a rim distance global maxima 200 and a rim distance global minima 210 relative to the first end 30 (FIG. 7). The rim distance global maxima 200 and rim distance global minima 210 are locations, not scalar quantities. The variation in rim distance 190 can provide for structures that function as a pour spout or weir to help control dispensing from the container 10. One practical arrangement is a core rim 180 that is an elliptical. For a cylindrical core layer 100, notwithstanding that there can be a small discontinuous portion following the height of the container 10, the core rim 180 can be defined by a cylindrical section.

The second end 40 can be above the rim distance global maximum 200 by more than the predetermined removable portion height 290. This can provide for enough space for the removed removable lid 90 to be fitted over the lobe 120 or lobes 120 to reclose the container 10.

To provide for improved structural stability of the container 10, at the rim distance global minima 210 the core layer 100 can extend above the upper line of limitation 80 by more than 5%, optionally from 5% to 75%, optionally from 5% to 50%, optionally from 5% to 30%, of the peripheral exterior length 130. In that arrangement, the core layer 100 can support the back of the lobe 120 or lobes 120 and the shell layer 20 of the body portion 50.

The rim distance global maxima 200 and the rim distance global minima 210 can be positioned such that the longitudinal axis L is between the rim distance global maxima 200 and the rim distance global minima 210. This arrangement can help the user easily identify the location along the core rim 180 that can be conveniently used to pour the contents of the container 10.

In one practical construction, the core layer 100 can be discontinuous at a position the longitudinal axis L at a location within 40 degrees, or even within 20 degrees, or event withing 10 degrees, or even within 5 degrees, of the rim distance global minima 210 as measured the longitudinal axis L. A discontinuity located as such can provide convenient design of the blank from which the container 10 is erected and provide the user a visual cue as to how the container 10 should be aligned in his or her hand when pouring from the container 10. The core layer 100 can be discontinuous over a width the longitudinal axis L. The width of the discontinuity 19 is the distance between the core layer side edges 21 at the core rim 180. As described herein, the core layer 20 extends between the core layer side edges 21 and for an erected container 10 the core layer 20 extends at least partially the longitudinal axis L, or even entirely the longitudinal axis L. The width can be measured between the core layer side edges 21. The width of the discontinuity 19 can be less than the minimum dimension of an laundry composition 270. The width of the discontinuity 19 can be sized and dimensioned to retain laundry composition 270 stored within the container 10. The width of the discontinuity 19 can be sized and dimensioned so that laundry composition 270 stored within the container 10 cannot pass through the discontinuity 19. This can reduce the potential for an laundry composition 270 to unintentionally pass through the discontinuity 19 when the container 10 is opened or the laundry composition 270 are dispensed from the container 10. The width can be less than or equal to the nominal sieve opening size at which 100 wt % of the laundry composition 270 in the container 10 is retained. The width of the discontinuity 19 can be smaller than the size of each of the individual laundry composition 270 in the container 10.

The longitudinal seam 230 can be within 40 degrees of the rim distance global minima 210 as measured the longitudinal axis L. Optionally the longitudinal seam 230 can be within 20 degrees, or within 10 degrees, or within 5 degrees of the rim distance global minima 210, as measured the longitudinal axis L. The blank for such a container 10 can be more convenient to design. And such a blank can be practically erected.

A variety of structures are contemplated for helping the user remove the predetermined removable portion 70 (FIG. 8). The predetermined removable portion 70 can comprise a free end 112 to initiate tearing of the predetermined removeable portion 70 from the container 10.

The user can pull on the free end 112 to initiate tearing of the predetermined removeable portion 70 away from the body portion 50 and removable lid 90. The free end 112 can have the shape a pull tab, such as a trapezoidal end, semicircular end, triangular end, or a curved end. The free end 112 can be peripherally more extensive than the upper line of limitation 80 and lower line of limitation 60. The free end 112 can be from 1 mm to 5 mm peripherally more extensive than the upper line of limitation 80 and the lower line of limitation 60. The free end 112 or tear strip 110 can be located at the longitudinal seam 230. Located as such, the lower line of limitation 60 and upper line of limitation do not need to cross the longitudinal seam 230. That may reduce the potential for tearing the longitudinal seam 230 when the predetermined removeable portion 70 is torn from the container 10.

The free end 112 of the predetermined removeable portion can be located where the core layer 100 is discontinuous the longitudinal axis L. Such a location can simplify the design of the blank from which the container 10 is constructed since the end of the tear strip 110 can be located at a transverse edge of the blank. If the container 10 is provided with a core rim 180 that that is at an angle relative to the longitudinal axis L or is provided with some other structure to improve dispensing from the container 10, the free end 112 can be within 40 degrees, optionally within 20 degrees, optionally within 10 degrees, optionally within 5 degrees of the longitudinal seam 230 as measured the longitudinal axis L. The longitudinal seam 230 can be unconnected or weakly connected beneath the predetermined removeable portion 70 so that the predetermined removeable portion 70 can be easily separated from the container 10 proximal the longitudinal seam 230. The longitudinal seam 230 can extend from the first end 30 to the second end 40 excluding the predetermined removable portion 70. The longitudinal seam 230 can extend from the first end 30 to the second end 40 excluding the predetermined removable portion 70 and be glued, taped, or heat sealed along the longitudinal seam 230.

By way of nonlimiting example, as shown in FIG. 8, a line of frangibility 160 can be defined by a plurality of structural disruptions 16 of the shell layer 20 spaced apart from one another.

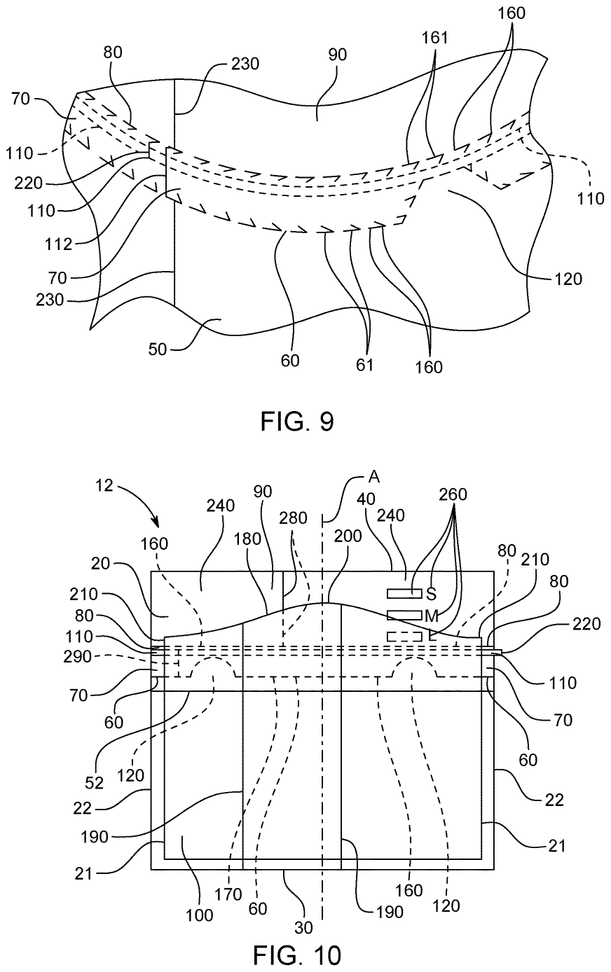

Additional detail of the optional tear strip 110, which is described previously, is shown in FIG. 9, which is a partial view of a container 10. The optional tear strip 110 can provide for improved control of removing the predetermined removable portion 70 from the container 10. The tear strip 110 can have an initiation end 220 that is external to the container 10. If the container 10 is provided with a core rim 180 that is at an angle relative to the longitudinal axis L or is provided with some other structure to improve dispensing from the container 10, the tear strip 110 can have an initiation end 220 that is within 40 degrees, optionally within 20 degrees, optionally within 10 degrees, optionally within 5 degrees of the global minima 210 as measured the longitudinal axis L. Such arrangements can be practical so that the tear strip 110 starts proximal to or at the longitudinal seam 230.

The optional tear strip 110 can be located where the core layer 100 is discontinuous the longitudinal axis L. Such a location can simplify the design of the blank from which the container 10 is constructed since the end of the tear strip 110 can be located at a transverse edge of the blank. When the container 10 is erected, the tear strip 110 is positioned near the longitudinal seam 230.

By way of nonlimiting example, as shown in FIG. 9, a line of frangibility 160 can be defined by a plurality of structural disruptions 161 of the shell layer 20 spaced apart from one another. The lobe 120 can be defined by more than two structural disruption 161.

The container blank 12 can be a laminate of paperboard materials. The blank 12 can comprise the paperboard shell layer 20. The shell layer 20 can comprise two transverse edges 22 on opposing sides of a central axis A. The paperboard shell layer 20 can comprise a first end 30 extending between the transverse edges 22 orthogonal to the central axis A. The paper board shell layer 20 can comprise a second end 40 opposite the first end and extending between the transverse edges 22. Like the container 10, the shell layer 20 of the blank 12 can comprise a body portion 50 extending from the first end 30 to the lower line of limitation 60. The shell layer 20 can comprise a predetermined removeable portion 70 extending from the lower line of limitation to an upper line of limitation 80. The upper line of limitation 80 can be orthogonal to or substantially orthogonal to the central axis A. The removable lid 90 can extend from the upper line of limitation 80 to the second end 40.

The paperboard core layer 100 can be provided in facing relationship with the shell layer 20. The core layer 100 can be glued, taped, or heat sealed to the shell layer 20 to provide for rigidity to the erected container 10 and provide blank that can be manipulated to erect a container 10. The core layer 100 can extend from below the lower line of limitation 60 to the core rim 180 above the upper line of limitation 80. The core layer 100 can be glued, taped, heat sealed, or otherwise joined to the shell layer 20.

The core layer 100 can extend from and be unitary with one of the transverse edges 22 and be foldable the transverse edge 22. That is, a single sheet of paperboard can form both the shell layer 20 and the core layer 100. Constructing the blank 12 from a single sheet of paperboard can be attractive since individual sheets of paperboard do not need to be precisely positioned with respect to one another during assembly. Further, a single die cut can be made to construct the shell layer 20 and the core layer 100 from a single flat sheet. The single die cut sheet can be folded along the intended location of the transverse edge 22 to bring the core layer 100 into facing relationship with the shell layer 20 to form the two layer blank 12. Optionally, the core layer 100 and shell layer 20 can be nonunitary. For example, the shell layer 20 and the core layer 100 can be individual pieces of paperboard that are assembled to form the blank 12.

When the core layer 100 is in facing relationship with the shell layer 20, the core rim 180 can be located at a rim distance 190 from the first end 30 as measured parallel to the central axis A. The rim distance 190 can be constant if a core rim 180 that is defined by a circle perpendicular to the longitudinal axis L is desired for the container 10.

The rim distance 190 can be a function of the distance from the central axis A. Such an arrangement can be used to create a core rim 180 that varies in distance from the bottom edge 30 as a function of position the longitudinal axis L of the container 10. When the core layer 100 is in facing relationship with the shell layer 20, the core rim 180 can have a rim distance 190 global maxima 200 and a rim distance global minima 210 relative to the first end 30. When such a blank 12 is erected into a container 10, the global maxima 200 and global minima 210 correspond to the same discussed above with respect to the container 10. The global maxima 200 can be located at the central axis A. When the container 10 is erected, the global maxima 200 can be opposite the longitudinal seam 230.

The core rim 180 of the blank 12 can be sinusoidal. A blank 12 having a sinusoidal core rim 180 can be erected to provide a container 10 in which the core rim 180 is a cylindrical section. The core rim 180 can be defined by two straight line segments 170 having an interior angle less than 170 degrees. The two straight line segments 170 can approach the central axis A. The interior angle is the interior angle over the over the core layer 100. When a blank 12 constructed as such is rolled the longitudinal axis L, the resulting core 180 is sloped relative to the first end 30. The transverse edges of the core layer 100 can be shorter than the core layer 100 along the central axis A.

The blank 12 can be designed so that the second end 40 is away from the first end 30 by a distance greater than the rim distance global maxima 200 plus a maximum distance between the upper line of limitation 80 and the lower line limitation 60 measured parallel to the central axis A. This can provide for the removable lid 90 being able to fit over the part of the core layer 100 that sits above the lower line of limitation 60. Similarly, the removable lid 90 can have a removable lid height 280 measured parallel to the central axis A between the upper line of limitation 80 and the second end 40. The predetermined removeable portion 70 can have a predetermined removeable portion maximum height 290 measured parallel to the central axis A and the removable lid height 280 can be greater than the predetermined removeable portion height 290.

To provide for enhanced control of the tearing path of the predetermined removable portion 70, the predetermined removable portion 70 can extend between and intersect the transverse edges 22 of the shell layer 20.

The lines of frangibility 160 can be provided in the blank 12. If the layers of paperboard are die cut, the die can include crease and cutting knives, partial cutting knives, reversed partial cutting knives or perforations, knives, or combinations thereof or other structures to form the lines of frangibility 160. Optionally, the lines of frangibility 160 can be formed in the shell layer 20 after die cutting the overall shape of the shell layer 20 and core layer 100, for instance by another die or applying a score line or intermittent score line or laser cut or the like to the shell layer 20.

To form a container 10 in which the core layer 100 sticks up above the lower line of limitation 60 sufficiently to act as a guide for replacing the removable lid 90 onto the body portion 50 to reclose the container, the core layer 100 can extend above the upper line of limitation 80 by more than 5%, or from 5% to 50%, optionally from 5% to 30%, of the body portion length 52. The body portion length 52 is measured between the transverse edges 22 orthogonal to the central axis A immediately below the lower line of limitation 60.

An optional tear strip 110 can be joined to the predetermined removable portion 70 before or after die cutting of the shell layer 20. The optional tear strip 110 can be between the core layer 100 and the shell layer 20.

The lobe or lobes 120 can be provided in the blank 12. The body portion 50 can comprise a lobe 120 immediately below the lower line of limitation 60. The body portion 50 can have a body portion length 52 measured between the transverse edges 22 orthogonal to the central axis A immediately below the lobe or lobes 120. The lobe or lobes 120 can have a lobe length 142 orthogonal to the central axis A and the lobe length can be more than 5%, optionally more than 10%, optionally from 5% to 30%, optionally from 5% to 20%, of the body portion length 52. Additionally, the lobe or lobes 120 can have a lobe exterior height 150 parallel to the central axis A and the lobe length 142 to lobe exterior height 150 ratio can be greater than 1.

Like the container 10, the blank 12 can comprise a plurality of lobes 120. And the upper line of limitation 80 can be orthogonal to the central axis A. The container blank 12 can comprise two lobes 120 spaced apart from one another by straight segments 170 of the lower line of limitation 60. The body portion 50 can comprise two lobes 120 and the lobes 120 can be on opposite sides of the central axis A. The lobes 120 can be spaced apart from one another by from 10% to 80% of the lobe length 142.

The lobe or lobes 120 provided as part of the blank can be sized and dimensioned to provide the lobe or lobes 120 in the erected container 10. The lobes 120 can be spaced apart from one another from 10% to 80% of the lobe length 142. The lobe or lobes 120 can have a curved upper contour 122 and the lobes 120 adjacent one another can have lobe exterior heights 150 that vary from one another.

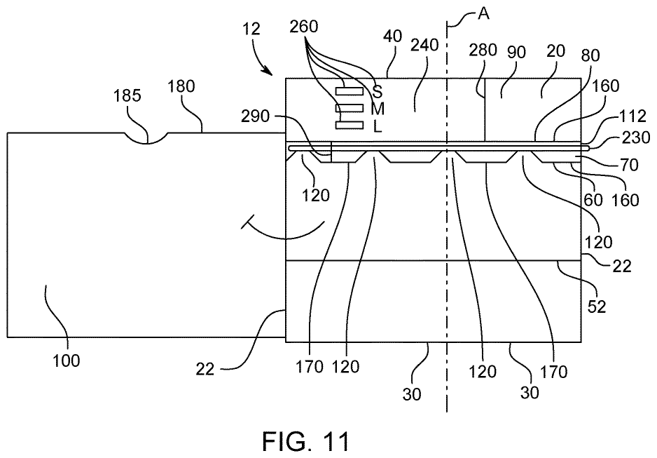

A similar blank 12 is shown in FIG. 11, the blank 12 in FIG. 11 can be formed of a unitary sheet of paper board. The die cut blank 12 can be shaped as desired and the lines of frangibility 160 can be provided. If desired, a tear strip 110 can be joined to the shell layer 20 in the desired location. The lines of frangibility 160 can be provided before or after joining the tear strip 110 to the predetermined removable portion 70.

The core layer 100 can be folded the transverse edge 22 to form the blank 12 to bring the core layer 100 shell layer 20 into facing relationship with the core layer 100 overlying the predetermined removable portion 70. The core layer 100 can be optionally glued, taped, or heat sealed to the shell layer 20 to provide for rigidity to the erected container 10.

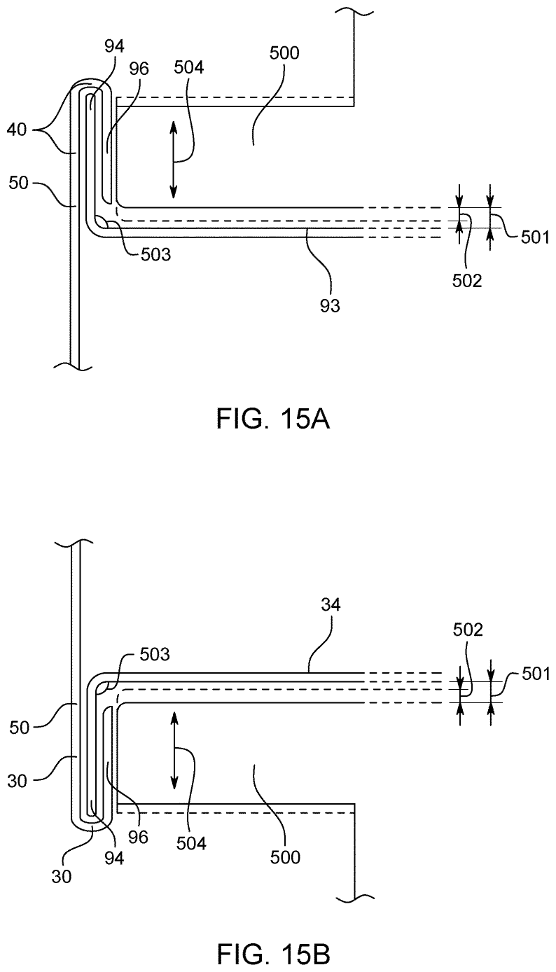

Providing a core layer 100 in which at least parts of the two core layer side edges 21 abut or overlap one another can be practical (FIGS. 15 and 16). The parts of the core layer side edges 21 that abut or overlap one another can be at least between the lower line of limitation 60 and the upper line of limitation 80. The parts of the core layer side edges 21 that abut or overlap one another can be between the first end 30 and the upper line of limitation 80. The parts of the core layer side edges 21 that abut or overlap one another can extend only partway between the first end 30 and the upper line of limitation 80. Providing only part of the of the two core layer side edges 21 abutting or overlapping one another can improve the ability to handle and erect the blank 12 for forming the container 10.

The core layer 100 can have two core layer side edges 21 and the core layer 100 can extend between the side edges 21 the longitudinal axis L. Such an arrangement can result in a locally thick portion of the container from the base 32 along the height of the container 10. After the container 10 is opened, the removable lid 90 can be wedged or otherwise forced over the lower line of limitation 60 at the body portion 50 to tightly engage the removable lid 90 with the body portion 50. The removable lid 90 can have enough flexibility or deformability to be stretched or fitted over the lower line of limitation 60 the periphery of the body portion 50 the longitudinal axis L or the body portion 50 proximal the lower line of limitation 60 can be deformed to be wedged with the removable lid 90 fitted thereto. The wedge fit between the removable lid 90 and the body portion 50 can be sufficiently strong to help reduce the potential for the contents of the container 10 spilling when a previously opened container 10 that is closed with the removable lid 90 is accidentally tipped over or inverted. Providing an abutting or overlapping relationship in the side edges 21 of the core layer 100 can also help reduce the potential for the laundry composition 270 to spill out of the container 10 when the container 10 is opened, especially when the fill level 99 is above the lower line of limitation 60, and reduce the potential for messy pouring of the laundry composition 270 from a gap in the core layer 100 when the laundry composition 270 are dispensed from the container 10 if the body portion 50 is not carefully oriented so that a discontinuity in the core layer 100 is higher than the location on the core rim 180 over which the laundry composition 270 may be dispensed or poured. It may be noted that the removable lid 90 may have the same seam and shape as the shell layer 20 proximal the lower line of limitation 60. As such one or both of the body portion proximal the lower line of limitation 60 and the removable lid 90 proximal the lip 23 can be deformed so that the removable lid 90 can be wedge fitted to the body portion 50.

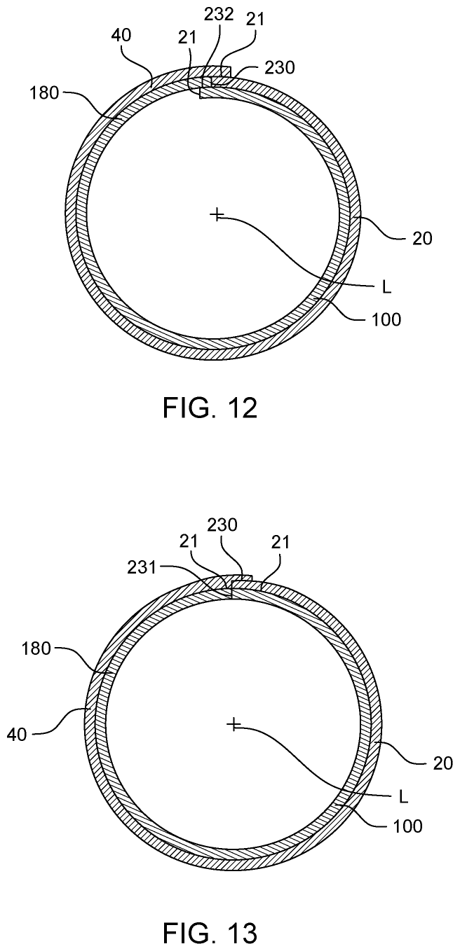

The side edges 21 of the core layer 100 can be joined to one another by a butt seam 231 or can be part of a longitudinal core overlapping seam 232. A butt seam 231 can be formed by taping or otherwise joining the side edges 21 of the core layer 100. A core overlapping seam 232 can be formed by gluing or heat sealing the side edges 21 in an overlapping relationship. The side edges 21 can be part of a longitudinal core overlapping seam 232. Optionally, the core overlapping seam 232 can nest with the overlapping longitudinal seam 230. A nonlimiting example of a nesting relationship is shown in FIG. 12. The overlapping longitudinal seam 230 and the core overlapping seam 232 overlap the longitudinal axis L in the same direction (for example clockwise or counterclockwise, counterclockwise being illustrated in FIG. 12) from outer to inner. Outer is used in this sense in that outer is further away from the longitudinal axis L than inner. Providing both the overlapping longitudinal seam 230 and the core overlapping seam 232 can provide for additional local wall thickness to the container 10 from the base 32 along the height of the container 10. After the container 10 is opened, the removable lid 90 can be wedged over the top of the body portion 50 to tightly engage the removable lid 90 with the body portion 50 by way of the same or similar mechanisms discussed previously with respect to the side edges 21 abutting one another.

For a container 10 that is a substantially right circular cylinder, providing a longitudinal core overlapping seam 232 or butt seam 232 can be practical in that the core layer 100 may not have a precisely circular cross section orthogonal to the longitudinal axis L. If the shell layer 20 has longitudinal seam 230 that is an overlapping seam, the removable lid 90 may not have a precisely circular cross section orthogonal to the longitudinal axis L. Since the shell layer 20 and the core layer 100 may be joined to one another and the constituent paperboard materials have some flexibility, the core layer 100 may conform, at least to some degree, with the shape of the shell layer 20 orthogonal to the longitudinal axis L. After removing the removable lid 90, the removable lid 90 can be refitted to the core layer 100. The substantially circular cross section of the removable lid 90, which is formed from the shell layer 20, and the core layer 100 orthogonal to the longitudinal axis L can be wedge fitted to one another by positioning the longitudinal seam 230 of the shell layer out of alignment with the core overlapping seam 232 when the removable lid 90 is refitted to the core layer 100. This may be achieved by positioning the longitudinal seam 230 out of alignment with the core overlapping seam 232 before fitting the removable lid 90 onto the core layer 100. This may optionally be achieved by fitting the removable lid 90 onto the core layer 100 with the longitudinal seam 230 and core overlapping seam 232 position the longitudinal seam 230 in alignment or near alignment and then slightly rotating the removable lid 90 the longitudinal axis L to cam the interior of the removable lid 90 with the exterior of the shell layer 20. The engagement mechanism may be thought of as being similar to taking two concentric ovals and slightly rotating one of the ovals the longitudinal axis relative to the other. The shape of the outer oval can resist relative rotation of the inner oval, or vice versa, and at some degree of rotation amongst the ovals the combination of the normal force developed between the two ovals and the coefficient of friction of the material forming the ovals can fix the rotational relationship between the ovals within some range of applied rotational force in either direction the longitudinal axis L. That developed friction force can also resist separation of the removable lid 90 from the shell layer 20 in the direction of the longitudinal axis L. Since the core layer 100 and shell layer 20 are paperboard materials, removable lid 90 and the part of the core layer 100 above the lower line of limitation 60 can deform slightly to reasonably securely engage the removable lid 90 with the core layer 100. This engagement mechanism may not require as much deformation as an engagement mechanism in which the lip 23 of the removable lid 90 is fitted over the shell layer 20 proximal the lower line of limitation 60.

The two side edges 21 and the overlapping longitudinal seam 230 can be within 15 degrees of one another the longitudinal axis L.

Providing a core layer 100 in which at least parts of the two core layer side edges 21 abut or overlap one another can be practical for providing a continuous core rim 180. A continuous core rim 180 can be desirable for enabling the laundry composition 270 in the container 10 to be dispensed or poured out of the container 10 at any position the longitudinal axis L. A continuous core rim 180 can also allow the laundry composition 270 to be filled to a fill level 99 above the lower line of limitation 60 and below the lowest location on the core rim 180.

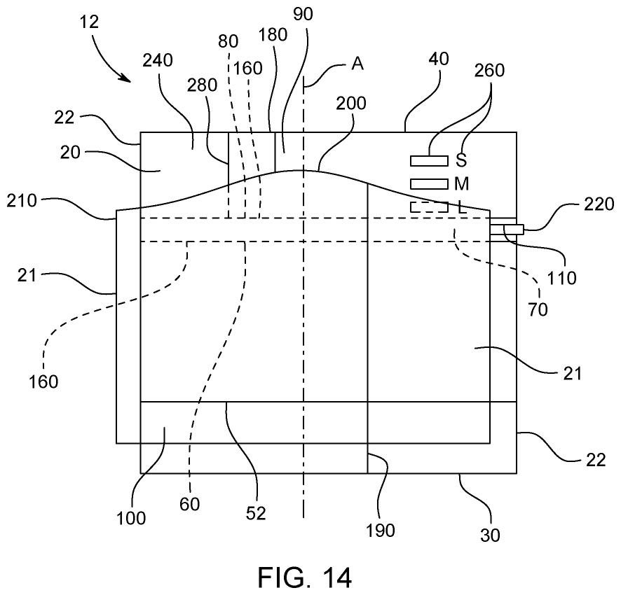

A blank 12 for forming a container 10 having a core layer 100 having a butt seam 231 or core overlapping seam 232 is shown in FIG. 14. To form such a butt seam 231 or core overlapping seam 232, the paperboard core layer 100 can comprise two core layer side edges 21. When the core layer 100 is in facing relationship with the shell layer 20, the core layer 100 extends from below the lower line of limitation 60 to the core rim 180 above the upper line of limitation and one of the side edges 21 is further away from the central axis A than one of the transverse edges 22. Optionally, the core layer 100 can extend from and be unitary with one of the transverse edges 21 and be foldable one of the side edges 21. The central axis A can be between the free end 112 and the side edge 21 that is further away from the central axis A than one of the transverse edges 22 is. The attributes of the of the other blanks 12 described herein are common to the blank 12 shown in FIG. 14 to the extent that such attributes can be consistent with a blank 12 in which the core layer 100 is offset from the shell layer 20 with respect to the central axis A as shown in FIG. 14. The blank 12 shown in FIG. 14 can be folded or rolled around a mandrel to bring one of the side edges 21 into an abutting relationship with the other side edge 21 to form a butt seam 231 in the core layer 100. Optionally, one of the side edges 21 can be positioned further away from the central axis A so that there is a sufficient overlap of the core layer 100 to form core overlapping seam 232 when the blank 12 is folded or rolled around a mandrel.

### Laundry Compositions

The container 10 can be practical for containing a laundry composition 270 including, but not limited to, laundry scent additive particles, granular laundry detergent, soluble unit does pouches of laundry detergent, laundry detergent tablets, granular dish detergent, soluble unit dose pouches of dish detergent, dish detergent tablets, laundry benefit additives, chlorine tablets, hard surface cleaning tablets, bead-based laundry products. The container can contain a laundry composition 270 that comprise perfume. The container can contain a laundry composition 270 that comprise unencapsulated perfume. The laundry composition 270 can be particles. The laundry composition 270, which can be particles, can comprise a water soluble or water dispersible carrier and perfume. The laundry composition 270, which can be particles, can comprise from 1 wt % to 99 wt % a water soluble or water dispersible carrier and from 0.1 wt % to 80 wt % a laundry benefit agent. The laundry benefit agent can be selected from the group consisting of perfume, fabric softener, wrinkle releaser, color protector, color rejuvenator, soil release polymer, antistatic agent, malodor reduction agent, antimicrobial, anti-redeposition compound, optical brightener, graying inhibitor, dye transfer inhibitor, antioxidant, and combinations thereof. The laundry composition 270, which can be particles, can have an individual laundry composition 270 mass from 1 mg to 2 g. The water-soluble carrier can be a water-soluble salt, water-dispersible solid, water-soluble carbohydrate, water-dispersible carbohydrate, water-soluble polymer, water-dispersible polymer, by way of nonlimiting examples, sodium chloride, sugar, starch, polysaccharide, polyethylene glycol, block copolymers, and the like.

The container 10 can be practical for containing goods such as food products including, but not limited to, pasta, rice, tea, flour, baking powder, baking soda, potato chips, pretzels, cereal, oats, barley, beans, seasonings, cookies, nutritional supplements, pelleted food products, crackers, and the like. The container 10 can be practical for containing medicinal pills, vitamins, nutritional supplements, dry pet food, dry pet snacks, and the like.

The container 10 can be sized and dimensioned to contain less than 1500 g of laundry composition 270, for example particles. The laundry composition 270 can be a laundry benefit product.

The laundry composition 270 can be particles that comprise a water-soluble or water-dispersible carrier and a laundry benefit agent selected from the group consisting of unencapsulated perfume, encapsulated perfume, surfactant, enzyme, bleach, brightener, hueing dye, deposition aid, antiredeposition aid, foam inhibitor, fabric softener, dye transfer inhibitor, soil release polymer, antioxidant, and combinations thereof.

The container 10 can contain from 30 g to 1200 g, optionally from 100 g to 800 g, optionally from 100 g to 600 g, of articles.

The granular laundry composition can be understood to be a solid free-flowing particulate laundry composition or the granular laundry composition can be incorporated into a water-soluble unit dose article. The skilled person is aware of the characteristics of a solid free-flowing particulate laundry composition.

Typically, a water-soluble unit dose article comprises a water-soluble non-woven sheet, wherein: the non-woven sheet is shaped to create an internal compartment and the granular laundry composition is housed within said compartment; or the non-woven sheet is orientated into layers, the layers stacked on top of one another, and the granular laundry composition is positioned between said layers.

The water-soluble fibrous non-woven sheet comprises a plurality of fibers. Preferably, the fibers are inter-entangled fibers in the form of a fibrous structure. The water-soluble fibrous non-woven sheet may be homogeneous or may be layered. If layered, the water-soluble fibrous non-woven sheet may comprise at least two and/or at least three and/or at least four and/or at least five layers.

Preferably, the water-soluble fibrous non-woven sheet has a basis weight of between 20 gsm and 60 gsm, preferably between 20 gsm and 55 gsm, more preferably between 25 gsm and 50 gsm, most preferably between 25 gsm and 45 gsm. Those skilled in the art will be aware of methods to measure the basis weight.

By ‘fiber’ we herein mean an elongated element having a length exceeding its average diameter, preferably, a length to average diameter ratio of at least 10. Preferably, each fiber may have a length of greater than or equal to 5.08 cm, greater than or equal to 7.62 cm, greater than or equal to 10.16, greater than or equal to 15.24 cm or a mixture thereof. Alternatively, each fiber may have length of less than 5.08 cm, less than 3.81 cm, less than 2.54 cm, or a mixture thereof. Each fiber may have a width of less than 100 μm, less than 75 μm, less than 50 μm, less than 25 μm, less than 10 μm, less than 5 μm, less than 1 μm or a mixture thereof. Those skilled in the art will be aware of standard methods and techniques to measure the width. Preferred methods include Scanning Electron Microscope (SEM) or an Optical Microscope together with image analysis software.

The water-soluble fibrous non-woven sheet may comprise a plurality of identical or substantially identical, from a compositional perspective, fibers. Alternatively, the water-soluble fibrous non-woven sheet may comprise two or more different fibers. Non-limiting examples of differences in the fibers may be physical differences such as differences in diameter, length, texture, shape, rigidness, elasticity, and the like; chemical differences such as crosslinking level, solubility, melting point, Tg, active agent. Preferably, the fibers are present between 80% and 95%, preferably between 85% and 93%, more preferably between 87% and 90% by weight of the water-soluble fibrous non-woven sheet.

The water-soluble fibrous non-woven sheet may exhibit different regions, such as different regions of basis weight, density, and/or caliper. The water-soluble fibrous non-woven sheet may comprise texture on one or more of its surfaces. A surface of the water-soluble fibrous non-woven sheet may comprise a pattern, such as a non-random, repeating pattern. The water-soluble fibrous non-woven sheet may have a thickness between 0.01 mm and 100 mm, preferably between 0.05 mm and 50 mm, more preferably between 0.1 mm and 20 mm, even more preferably between 0.1 mm and 10 mm, even more preferably between 0.1 mm and 5 mm, even more preferably between 0.1 mm and 2 mm, even more preferably between 0.1 mm and 0.5 mm, most preferably between 0.1 mm and 0.3 mm. Those skilled in the art will be aware of standard methods to measure the thickness.

The fibers may comprise a polyvinyl alcohol polymer. Preferably, the fibers comprise between 50% and 98%, preferably between 65% and 97%, more preferably between 80% and 96%, even more preferably between 88% and 96% by weight of the fiber of polyvinyl alcohol. The polyvinyl alcohol polymer may have a weight average molecular weight of between 50 kDa and 150 kDa, preferably between 75 kDa and 140 kDa, more preferably between 100 kDa and 130 kDa. “Weight average molecular weight” as used herein means the weight average molecular weight as determined using gel permeation chromatography. Those skilled in the art will be aware of other known techniques to determine the weight average molecular weight (MW).

Preferably, the polyvinyl alcohol polymer is a polyvinyl alcohol homopolymer. Preferably, the polyvinyl alcohol homopolymer has an average percentage degree of hydrolysis of from 75% to 100%, preferably of from 80% to 95%, most preferably of from 85% to 90%. Preferably, the polyvinyl alcohol homopolymer has an average viscosity of from 1 to 30 mPas, preferably from 5 to 25 mPas, most preferably from 10 to 20 mPas, wherein the viscosity is measured as a 4% aqueous solution in demineralized water at 20 °C.

The fibers preferably comprise between 0.1% and 15% by weight of the fibers of a gel-breaker, wherein the gel-breaker is selected from polyols, sugar alcohols, amines, amides, carbohydrates, multivalent cations, or a mixture thereof, preferably polyols, sugar alcohols or a mixture thereof. Preferably, the fibers comprise between 1% and 12%, preferably between 2% and 10% by weight of the fibers of the gel-breaker.

Typically, the granular laundry composition is a fully formulated laundry composition, not a portion thereof such as a spray-dried, extruded or agglomerate particle that only forms part of the laundry composition. Typically, the granular laundry composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Suitable laundry compositions comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; brighteners; chelants; hueing agents; dye transfer inhibitors; dye fixative agents; perfume; silicone; fabric softening agents, such as clay; flocculants, such as polyethyleneoxide; suds supressors; and any combination thereof.

### Process of Sealing Packaging Parts

The present disclosure relates to the process of sealing packaging parts comprising cellulosic material.

During the process, ultrasonic generators (not shown) may produce high frequency oscillation movements that may be transmitted through a sonotrode (500), generating localized heat at the interface of the materials being sealed, i.e. on the cellulosic layers.

Sonotrodes (500) may usually be made from high-strength materials such as titanium or aluminum, which can withstand the mechanical stresses associated with ultrasonic vibrations while maintaining performance. The sonotrode (500) may be integrated with ultrasonic generators and boosters, which may enhance the ultrasonic vibrations before they are transmitted to the sonotrode (500). The skilled person is aware of the functioning and structure of a sonotrode (500). A sonotrode from Telsonic AG is suitable.

Suitable sonotrodes (500) may comprise a peripheral toroidal surface.

Suitable sonotrodes (500) may be adapted to establish continuous annular (perimetral) contact with a target surface in order to perform a sealing operation, especially when sealing the top or bottom disks of a cylindrical packaging.

The sonotrode (500) may perform a sealing force that may act perpendicularly or in parallel to the surface of the cellulosic material to be sealed, preferably perpendicularly.

The sonotrode (500) may oscillate in parallel or perpendicularly to the surface of the cellulosic material to be sealed, preferably in parallel.

Before or during the oscillation of the sonotrode (500), the sonotrode (500) directly contacts one of the two surfaces to be sealed. The sonotrode (500) may keep the surfaces in position, optionally aided by an external clamp, and generating relative movement between the two surfaces, thus producing friction heat at the interface between the two surfaces. A clamp (not shown) may be used on the other side of the two surfaces to be sealed relative to the sonotrode (500) to keep the surfaces pressed between said clamp and the sonotrode (500).

FIG. 15A and FIG. 15B show a top junction and a bottom junction of the cylindrical container (10) respectively, before or during the ultrasonic sealing process. The junctions are formed by the respective end (30,40) of the body portion (50), by the folding extension (96) integrally extending from the respective end (30,40) of the body portion (50), by the respective closure (34, 93) and by the flanges (94) integrally extending from the respective closure (34, 93). The flange (94) is bent and has a surface creating an angle (503) of around 90°with the surface of the respective closure (34, 93). The flange (94) is tucked in between the respective end (30,40) of the body portion (50) and the folded extension (96) to create a three-layered junction.

By junction, it is herein intended a complex of two, three or more cellulosic layers, that is ready for being sealed by ultrasonic sealing. The junction may be sealed into a two-layer seal, three-layer seal or more. Additional unsealed layers of cellulosic layers may be present in the junction.

In FIG. 5A, a sonotrode (500) is positioned at a first distance (501) above the second closure (93) and in direct contact with the folded extension (96) (distance shown exclusively for improving clarity).

In FIG. 5B, a sonotrode (500) is positioned at a first distance (501) below the first closure (34) and in direct contact with the folded extension 96 (distance shown exclusively for improving clarity).

When the sonotrode (500) oscillates in a longitudinal direction (504), the sonotrode (500) moves up and down sequentially of a second distance (502). The second distance (502) is lower than the first distance (501), so that upon oscillation, the sonotrode (500) does not come into contact with the respective closure (34, 93). The first oscillation of the sonotrode (500) seals the external side of the flange (94) and the internal side of the folded extension 96 to create a double-layer seal.

In a second aspect, the present disclosure relates to a process of sealing packaging parts, the process comprising the following steps:
a) providing a cylindrical container (10) comprising a body portion (50) and one or two opened ends (30,40), and providing one or two closures (34, 93), wherein the closures (34, 93) each comprise a flange (94) at their perimetral rim;
b) positioning the closures (34, 93) so that the flange (94) is in perimetral contact with the opened ends (30,40);
c) positioning a sonotrode (500), so that
   i) the sonotrode (500) is in contact with the closures (34, 93), with the ends (30, 40), or combinations thereof, or
   ii) the sonotrode (500) is at a distance from the closures (34, 93), from the ends (30, 40), or combinations thereof, so that, upon oscillation of the sonotrode (500), the sonotrode (500) contacts the closures (34, 93), the ends (30, 40), or combinations thereof; and
d) oscillating the sonotrode (500) to ultrasonically seal the flange (94) to the respective end (30, 40) to form a seal,
   optionally wherein the process is used to make the products of claim 1-6.

This process can occur to seal the top disk (93) to the second end (40), i.e. to the cap wall (92), or to seal the bottom disk (34) to the first end (30), or combinations thereof.

Without wishing to be bound by theory, this process can create a cellulosic cylindrical container by sealing the bottom disk, and the top disk, without the need for an external heat source such as hot air. This leads to the prevention of fires in the manufacturing plants by way of preventing the exposure of paper-based packaging to temperatures at or above the ignition point. Also, a surprising speed of the sealing process is observed compared to sealing by hot air or glue.

In one aspect, during step d, the flange (94) and the respective end (30, 40) reach a temperature of less than 200 °C, preferably between 80 °C and 150 °C, more preferably between 100 °C and 130 °C.

It is believed that, by reaching a temperature below the paper ignition temperature (218-260 C) of the cellulosic layers, the ultrasonic sealing as described in the present disclosure reduces the fire hazard in manufacturing plants.

In one aspect, the sonotrode (500) may be positioned at a distance (501) of between 0 mm and 10 mm, preferably between 0.05 mm and 5 mm, more preferably between 0.1 mm and 3 mm, or even between 0.2 mm and 3 mm, or even between 0.5 mm and 3 mm from the closures (34,93).

In one aspect, when the sonotrode (500) oscillates, the sonotrode (500) may move of a distance (502) of between 0.05 mm and 9.95 mm, preferably between 0.05 mm and 4.95 mm, more preferably between 0.1 mm and 2.95 mm, most preferably between 0.05 mm and 1.95 mm, preferably, in a longitudinal direction (504). A preferred distance (502) is around 0.1 mm.

In one aspect, the frequency of the sonotrode may be between 5,000 Hz and 50,000 Hz, preferably 10,000 Hz and 30,000 Hz, more preferably between 15,000 Hz and 30,000 Hz, most preferably between 15,000 Hz and 25,000 Hz.

Preferably, when the sonotrode oscillates, the sonotrode moves of a distance of around 0.1 mm with a frequency of around 20,000 Hz.

The duration of the first oscillation of the sonotrode (500) may be between 50 and 1,000 milli seconds, preferably be between 50 and 500 milli seconds, more preferably between 100 and 300 milli seconds, most preferably between 100 and 200 milli seconds.

The duration of any subsequent oscillation may be between 50 and 1,000 milli seconds, preferably between 50 and 500 milli seconds, more preferably between 100 and 300 milli seconds, most preferably between 100 and 200 milli seconds.

During the first oscillation, the sonotrode contacts one of the surfaces to be sealed (e.g. the ends (30,40)). In the second or any subsequent oscillation, the sonotrode may contact the other surfaces to be sealed (e.g. the closures (34,93)). The sonotrode may be shifted between the first and any subsequent oscillation. During the shift, the oscillation may or may not be interrupted. During the first oscillation, the sonotrode (500) may already be or come into contact with all the surfaces to be sealed.

In a preferred aspect, the flange (94) may have a surface forming an angle (503) of between 45°and 135°, preferably between 70°and 110°, more preferably between 80°and 100°, with the surface of the respective closure (34, 93), wherein the respective flange 94 may be tucked in between the respective end (30,40) of the body portion (50) and a folded extension 96 integrally extending from the respective end (30,40) of the body portion 50, wherein the folded extension (96) may be substantially parallel to the flange (94).

Without wishing to be bound by theory, a three-layered system of this type creates a stable junction on the top and/or bottom disk of a cylindrical packaging which can be subject to either a double-layer or a triple-layer sealing by ultrasonic sealing.

In one aspect, the sonotrode (500) may be positioned at a distance from the folded extension (96) of between 0 mm and 10 mm, or even between 0.05 mm and 5 mm, or even between 0.1 mm and 3 mm, or even between 0.2 mm and 3 mm, or even between 0.5 mm and 3 mm, particularly when the sonotrode (500) oscillates perpendicularly to the surface of the folded extension (96).

Preferably, the sonotrode (500) is in contact with the folded extension (96) and oscillates in parallel to the surface of the folded extension (96).

In a preferred aspect, in step c, the sonotrode (500) may be positioned, either in contact with the folded extension (96) or at a distance from the folded extension (96) so that, upon oscillation of the sonotrode (500) in step d, the sonotrode contacts the folded extension (96), preferably wherein, upon oscillation of the sonotrode (500) in step d, the sonotrode (500) does not contact the closures (34,93).

Without wishing to be bound by theory, the contact of the sonotrode (500) with the folded extension (96) provides for an internal sealing of the flange (94) with the folded extension (96), which creates a strong seal in a quick way and solves the “raised lip” problem. If the sonotrode (500) also contacts the closures (34,93), a triple-layer seal will be formed.

In a preferred aspect, the internal side of the respective end (30,40) of the body portion (50) and the external side of the respective flange (94) may be sealed, or the internal side of the respective flange (94) and the external side of the folded extension (96) may be sealed, or combinations thereof, preferably the internal side of the respective flange (94) and the external side of the folded extension (96) may be sealed.

Without wishing to be bound by theory, a double-layer seal is preferably formed between the two internal cellulosic layers, because it provides a strong seal in a quick way, whereas a triple-layer seal is particularly advantageous for creating a stronger seal.

In a preferred aspect, at least a portion of the internal side of the respective end (30,40) of the body portion (50) and the external side of the respective flange (94) may comprise a heat-sealant coating associated to the cellulosic layer, or at least a portion of the internal side of the respective flange (94) and the external side of the folded extension (96) may comprise a heat-sealant coating associated to the cellulosic layer, or combinations thereof, wherein the oscillation of step d may seal together two adjacent heat-sealant coatings, preferably, wherein the heat-sealant coating is a polymeric heat-sealant coating, more preferably a plastic heat-sealant coating, most preferably a polyethylene heat-sealant coating.

Without wishing to be bound by theory, the presence of heat-sealant coating in the cellulosic materials aids the seal formation by ultrasonic sealing.

In a preferred aspect, the sonotrode (500) may oscillate in a direction (504) substantially perpendicular to the surfaces of the closures (34, 93) and may create a sealing force substantially perpendicular to the surface of the flange (94).

Without wishing to be bound by theory, the perpendicular oscillation of the sonotrode (500) compared to the closures (34, 93) results in a better and faster sealing due to a continuous contact between the sonotrode (500) and the cellulosic layers for the full duration of the oscillation.

In a preferred aspect, in step c, the sonotrode (500) may be positioned at a first distance (501) of between 0.2 mm and 20 mm, preferably between 0.2 mm and 10 mm, more preferably between 0.5 mm and 10 mm, most preferably between 1 mm and 3 mm, from the surface of the closures (34, 93), and wherein, in step d, the sonotrode (500) may contact the ends (30,40), optionally wherein the process may comprise a further step e, wherein, in step e, i) the sonotrode (500) is positioned in contact with the closures (34, 93) or at a distance from the closures (34, 93) so that, upon oscillation, the sonotrode (500) contacts the closures (34, 93), and ii) a second oscillation is performed.

It is believed that, a subsequent oscillation of the sonotrode (500) after the first oscillation of step d may contribute to the formation of a seal comprising three or more cellulosic layers.

The sonotrode (500) may be positioned in the tube or outside of the cylindrical packaging, preferably outside of the tube. The sonotrode (500) may be positioned internally or externally relative to the seal, preferably internally relative to the seal. For instance, as shown in FIG. 5A, the sonotrode (500) may be positioned above the second closure (93) and internally relative to the seal, i.e. not extending outside of the vertical projection of the seal. For instance, as shown in FIG. 5B, the sonotrode (500) may be positioned below the first closure (34) and internally relative to the seal, i.e. not extending outside of the vertical projection of the seal.

In a preferred aspect, upon oscillation, the sonotrode (500) moves of a second distance (502) up and down sequentially in a longitudinal direction (504), wherein the second distance is lower than the first distance (501), preferably wherein the difference between the first distance (501) and the second distance (502) is between 0.1 mm and 2 mm.

It is believed that, by positioning the sonotrode (500) at a certain distance from the closure (34, 93), the sealing can take place on pre-defined points of sealing to generate tailored seals to solve problems such as the “raised lip” problem.

The point of sealing is intended as the point onto the surface to be sealed where the sealing force acts to seal together said surface with a second surface.

### Process of Making a Packaged Product

In a third aspect, the present disclosure relates to a process for making a packaged product comprising a cylindrical container (10) according to claims 1-6 and a laundry composition (270), the process comprising the following steps: a) obtaining the cylindrical container (10), wherein the cylindrical container (10) comprises a body portion (50) having a closed first end (30) and an open upper end, wherein the first end (30) comprises a first closure (34); b) filling the cylindrical container (10) with the laundry composition (270) through the open upper end; and c) applying a removeable lid (90) to the open upper end of the cylindrical container (10), wherein the removable lid (90) comprises a second closure (93) and a lid wall (92), wherein the cylindrical container (10) and the removable lid (90) comprise cellulosic material, wherein the first closure (34) is sealed to the first end (30) by ultrasonic sealing, wherein the ultrasonic sealing seals a plurality of layers of cellulosic material, preferably two layers of cellulosic material, to form a first seal, or wherein the second closure (93) is sealed to the lid wall (92) in a second end (40) by ultrasonic sealing, wherein the ultrasonic sealing seals a plurality of layers of cellulosic material, preferably two layers of cellulosic material, to form a second seal, or combinations thereof.

The features described for the cylindrical container (10) of the first aspect may also apply to the cylindrical container (10) used to make the packaged product according to the process of the third aspect.

### Combinations

Clause 1. A cylindrical container 10 comprising cellulosic material, wherein the cylindrical container 10 comprises a first end 30 and a second end 40, wherein the first end 30 comprises a first closure 34 and the second end 40 comprises a second closure 93, wherein the first closure 34 is sealed to the first end 30, wherein the second closure 93 and a lid wall 92 are part of a removeable lid 90, wherein the second closure 93 is sealed to the lid wall 92, wherein the first closure 34 and the removable lid 90 comprise cellulosic material, characterised in that i) the first closure 34 is sealed by ultrasonic sealing to the first end 30, wherein the ultrasonic sealing seals a plurality of layers of cellulosic material, preferably the ultrasonic sealing seals three layers of cellulosic material, or ii) the second closure 93 is sealed by ultrasonic sealing to the lid wall 92, wherein the ultrasonic sealing seals a plurality of layers of cellulosic material, preferably the ultrasonic sealing seals three layers of cellulosic material, or iii) combinations thereof.

Clause 2. A cylindrical container 10 according to clause 1, wherein the cylindrical container 10 houses a laundry composition 270, wherein the laundry composition 270 is selected from a granular laundry composition, a liquid laundry composition, a unit-dose laundry composition or mixtures thereof, preferably a granular laundry composition.

Clause 3. A cylindrical container 10 according to clauses 1-2, wherein the laundry composition 270 has a mass of less than 1500 g, preferably between 100 g and 600 g, more preferably between 400 g and 600 g.

Clause 4. A process for making a packaged product comprising a cylindrical container 10 and a laundry composition 270, the process comprising the following steps: a) obtaining the cylindrical container 10, wherein the cylindrical container 10 comprises a closed first end 30 and an open second end 40, wherein the first end 30 comprises a first closure 34; b) filling the cylindrical container 10 with the laundry composition 270 through the second end 40; and c) applying a removeable lid 90 to the second end 40 of the cylindrical container 10, wherein the removable lid 90 comprises a second closure 93 and a lid wall 92, wherein the cylindrical container 10, the first closure 34 and the removable lid 90 comprise cellulosic material, characterized in that i) the first end 30 is sealed to the first closure 34 by ultrasonic sealing, wherein the ultrasonic sealing seals a plurality of layers of cellulosic material, preferably three layers of cellulosic material, or ii) the second closure 93 is ultrasonically sealed to the lid wall 92, wherein the ultrasonic sealing seals a plurality of layers of cellulosic, preferably three layers of cellulosic material, or iii) combinations thereof.

Clause 5. A process according to clause 4, wherein the laundry composition 270 is selected from a granular laundry composition, a liquid laundry composition, a unit-dose laundry composition, or mixtures thereof, preferably a granular laundry composition.

Clause 6. A process according to clauses 4-5, wherein each of the first closure 34, the first end 30, the second closure 93 and the lid wall 92 comprise a point of sealing, wherein the ultrasonic sealing has a sealing force acting perpendicularly to the surfaces of the first closure 34, the first end 30, the second closure 93 and the lid wall 92 in the point of sealing.

Clause 7. A process according to clauses 4-6, the point of sealing comprises a natural or polymeric coating, preferably a polymeric coating, more preferably a polyethylene polymeric coating, wherein the ultrasonic sealing melts the natural or polymeric coating in the point of sealing, wherein a plurality of the natural or polymeric coating are sealed together by the ultrasonic sealing.

Clause 8. A process according to clauses 4-7, wherein the ultrasonic sealing is performed by a sonotrode, wherein the sonotrode oscillates horizontally to the surfaces of the first closure 34, the first end 30, the second closure 93 and the lid wall 92.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cylindrical container comprising cellulosic material,
wherein the cylindrical container comprises a body portion having a first end and a second end,
wherein the first end comprises a first closure and the second end comprises a second closure, wherein the first closure is sealed to the first end,
wherein a second closure and a lid wall are part of a removeable lid, wherein the second closure is sealed to the lid wall in the second end,
wherein the removable lid comprises cellulosic material,
wherein the first closure is sealed to the first end by ultrasonic sealing, wherein the ultrasonic sealing seals a plurality of layers of cellulosic material to form a first seal, or
wherein the second closure is sealed to the lid wall by ultrasonic sealing, wherein the ultrasonic sealing seals a plurality of layers of cellulosic material to form a second seal, or combinations thereof.

2. The cylindrical container according to claim 1, wherein the first seal, the second seal, or combinations thereof, each have two layers of cellulosic material sealed together by ultrasonic sealing, and one additional unsealed layer of cellulosic material,
wherein the one additional unsealed layer of cellulosic material is the most external layer of cellulosic material in the seal.

3. The cylindrical container according to claim 1, wherein the first closure, the second closure, or combinations thereof, each comprise a flange at their perimetral rim, wherein the flange has a surface forming an angle of between about 45° and about 135° with the surface of the respective closure,
and wherein the first seal, the second seal, or combinations thereof, each comprise the respective flange tucked in between the respective end of the body portion and a folded extension integrally extending from the respective end of the body portion, wherein the folded extension is substantially parallel to the flange.

4. The cylindrical container according to claim 1, wherein the internal side of the respective end of the body portion and the external side of the flange are sealed, or
the internal side of the flange and the external side of the folded extension are sealed, or combinations thereof.

5. A cylindrical container according to claim 1, wherein at least a portion of the internal side of the respective end of the body portion and of the external side of the flange comprise a heat-sealant coating associated to the cellulosic layers, wherein the heat-sealant coatings are sealed together by the ultrasonic sealing,
or at least a portion of the internal side of the flange and of the external side of the folded extension comprise a heat-sealant coating associated to the cellulosic layers, wherein the heat-sealant coatings are sealed together by the ultrasonic sealing, or combinations thereof,
wherein the heat-sealant coating is a polymeric heat-sealant coating.

6. A cylindrical container according to claim 1, wherein the cylindrical container houses a laundry composition, wherein the laundry composition is selected from a granular laundry composition, a liquid laundry composition, a single unit-dose laundry composition or mixtures thereof,
wherein the laundry composition has a mass of less than abou 1500 g.

7. A process of sealing packaging parts, the process comprising the following steps:
a) providing a cylindrical container comprising a body portion and one or two opened ends, and providing one or two closures, wherein the closures each comprise a flange at their perimetral rim;
b) positioning the closures so that the flange is in perimetral contact with the opened ends;
c) positioning a sonotrode, so that
i) the sonotrode is in contact with the closures, with the ends, or combinations thereof, or
ii) the sonotrode is at a distance from the closures, from the ends, or combinations thereof, so that, upon oscillation of the sonotrode, the sonotrode contacts the closures, the ends, or combinations thereof; and
d) oscillating the sonotrode to ultrasonically seal the flange to the respective end to form a seal, wherein the process is used to make the products of claim 1.

8. The process according to claim 7, wherein the flange has a surface forming an angle of between about 45° and about 135°, with the surface of the respective closure,
wherein the respective flange is tucked in between the respective end of the body portion and a folded extension integrally extending from the respective end of the body portion, wherein the folded extension is substantially parallel to the flange.

9. The process according to claim 7, wherein, in step c, the sonotrode is positioned, either in contact with the folded extension or at a distance from the folded extension so that, upon oscillation of the sonotrode in step d, the sonotrode contacts the folded extension, wherein, upon oscillation of the sonotrode in step d, the sonotrode does not contact the closures.

10. The process according to claim 8, wherein the internal side of the respective end of the body portion and the external side of the respective flange are sealed, or
the internal side of the respective flange and the external side of the folded extension are sealed, or combinations thereof,
wherein the internal side of the respective flange and the external side of the folded extension are sealed.

11. A process according to claim 8, wherein at least a portion of the internal side of the respective endof the body portion and the external side of the respective flange comprise a heat-sealant coating associated to the cellulosic layer, or
at least a portion of the internal side of the respective flange and the external side of the folded extension comprise a heat-sealant coating associated to the cellulosic layer, or combinations thereof.
wherein the oscillation of step d seals together two adjacent heat-sealant coatings,
wherein the heat-sealant coating is a polymeric heat-sealant coating.

12. The process according to claim 7, wherein the sonotrode oscillates in a direction substantially perpendicular to the surfaces of the closures and creates a sealing force substantially perpendicular to the surface of the flange.

13. The process according to claim 7, wherein, in step c, the sonotrode is positioned at a first distance of between about 0.2 mm and about 20 mm from the surface of the closures, and wherein, in step d, the sonotrode contacts the ends,
wherein the process comprises a further step e, wherein, in step e, i) the sonotrode is positioned in contact with the closures or at a distance from the closures so that, upon oscillation, the sonotrode contacts the closures, and ii) a second oscillation is performed.

14. The process according to claim 13, wherein, upon oscillation, the sonotrode moves of a second distance up and down sequentially in a longitudinal direction, wherein the second distance is lower than the first distance, wherein the difference between the first distance and the second distance is between about 0.1 mm and about 2 mm.

15. A process for making a packaged product comprising a cylindrical container according to claim 1 and a laundry composition, the process comprising the following steps:
a. Obtaining the cylindrical container, wherein the cylindrical container comprises a body portion having a closed first end and an open upper end, wherein the first end comprises a first closure;
b. Filling the cylindrical container with the laundry composition through the open upper end; and
c. Applying a removeable lid to the open upper end of the cylindrical container, wherein the removable lid comprises a second closure and a lid wall,
wherein the cylindrical container and the removable lid comprise cellulosic material,
wherein the first closure is sealed to the first end by ultrasonic sealing, wherein the ultrasonic sealing seals a plurality of layers of cellulosic materialto form a first seal, or
wherein the second closure is sealed to the lid wall in a second end by ultrasonic sealing, wherein the ultrasonic sealing seals a plurality of layers of cellulosic material to form a second seal, or combinations thereof.
